(19) United States
(12) Patent Application Publication
(10) Pub. No.: US 2015/0196050 A1
(43) Pub. Date: Jul. 16, 2015

(54) TRANSFER SYSTEMS AND METHODS FOR COATING MATERIALS IN A MEMBRANE

(71) Applicant: WikiFoods, Inc., Cambridge, MA (US)

(72) Inventors: Karl Thomas Winkler, Bedford, MA (US); Pat Mon, Marlborough, MA (US); Daniel William Stone, Winthrop, MA (US)

(21) Appl. No.: 14/592,101

(22) Filed: Jan. 8, 2015

Related U.S. Application Data
(60) Provisional application No. 61/926,193, filed on Jan. 10, 2014.
(60) Provisional application No. 61/940,194, filed on Feb. 14, 2014.

(51) Int. Cl. A23P 1/08

(52) U.S. Cl. CPC A23P 1/084; A23V 2002/00

(57) ABSTRACT

Provided are methods and machines for enrobing and fully encapsulating food products in an edible composition.

### CROSS-REFERENCE TO RELATED APPLICATIONS

This application claims priority to U.S. provisional application Ser. No. 61/926,193, entitled “Coating Materials in a Membrane,” filed Jan. 10, 2014; and U.S. provisional application Ser. No. 61/940,194, entitled “Transfer Systems and Methods for Coating Materials in a Membrane,” filed Feb. 14, 2014.

### TECHNICAL FIELD

This disclosure relates to systems and equipment for encapsulating an edible payload in a coating of edible materials, and more particularly to edible and/or biodegradable vessels. More particularly, this disclosure relates to a system and equipment for encapsulating an edible payload in edible materials with minimum mechanical contact with the payload or coating of edible material.

### BACKGROUND

As edible materials used in the production of foods are developed, machines for processing, transferring and handling those edible materials are required to achieve viable commercial production levels of a finished product. Machines and machine components are necessarily designed for high production efficiency and to meet demands for increased production yield. Soft foods may present a challenge in that mechanical transfer and transport can damage the final product and/or processing intermediates. Therefore, machines, devices and methods of manufacture for delicate handing of food products for minimizing structural damage are sought.

### SUMMARY

This disclosure describes systems and methods for coating material in a membrane. In many instances, it is desirable to form the material into a desired shape prior to coating the material with the membrane. For example, it may be desirous to form yogurt or ice cream into a shape prior to coating the yogurt or ice cream. Described herein are systems for and processes of preparing the material into the desired shape, coating the material with a first substance, coating the material with a second substance that interacts with the first substance to form a layer around the material, and cleaning the coated material of undesirable substances following formation of the membrane.

Additional features and advantages of the subject technology will be set forth in the description herein, and in part will be apparent from the description, or may be learned by practice of the subject technology. The advantages of the subject technology will be realized and attained by the structure particularly pointed out in the written description and embodiments hereof as well as the appended drawings.

Some embodiments described herein provide an enrobing platform, for coating a payload with a fluid, including an inlet portion and an outlet portion opposite the inlet portion; and a base extending from the inlet portion to the outlet portion and defining a flow path for fluid introduced at the inlet portion and discharged from the enrobing platform at the outlet portion, the base comprising, adjacent the outlet portion, one or more projections extending upward into the flow path from a generally uniform plane of the base; wherein when a payload is introduced at the inlet portion, flow of the fluid conducts the payload from the inlet portion toward the outlet portion, and the one or more projections create disturbances in the fluid flow that rotate the payload prior to discharge of the payload from the enrobing platform at the outlet portion. The payload may comprise a food product. The fluid may comprise alginate. The platform may include one or more fluid sources positioned above the enrobing platform that are configured to form one or more fluid curtains extending transversely relative to the flow path. The fluid flow through the platform may be configured to create a laminar velocity profile of the fluid that is slower near the base and quicker toward a top surface of the fluid. The one or more fluid curtains may be configured to coat a top portion of the payload as the payload is conducted by the fluid along the flow path and under the one or more fluid curtains. The one or more fluid curtains may be configured to provide a first shear force on a top portion of the payload that is different than a second shear force on a bottom portion of the payload as the payload is conducted through the one or more fluid curtains, such that the first and second shear forces acting on the payload cause the payload to rotate. The first shear force may be imparted by a vertical force of the one or more fluid curtains flowing onto a front portion of the payload. At least one of the one or more fluid curtains may be positioned to be deposited on the platform at a position along the flow path downstream of the one or more projections. The one or more fluid sources may provide three fluid curtains. The one or more projections may comprise a plurality of elongate protrusions extending in a direction transverse to a flow path direction. The plurality of elongate protrusions may extend transversely substantially entirely across the flow path. The one or more projections may comprise a front ramp on a portion closest to the inlet portion, the front ramp comprising an oblique transition from a base plane to a point on the one or more projections that is above the base plane. The one or more projections may comprise a plurality of discontinuous protrusions extending upward from a base plane. The base may be inclined from the inlet portion to the outlet portion. A viscosity of the fluid, a shape of the one or more projections, a flow rate of the fluid flow along the flow path, and a mass of the payload may each be configured such that the payload will not contact any portion of the enrobing platform from the inlet portion to the outlet portion. The flow path may be defined by two opposing side walls extending transversely from the base and a rear wall connected to the two opposing side walls and extending transversely from the base.

This description provides a system for coating a payload, including: an enrobing platform having a base, an inlet wall, two opposing side walls, and an outlet edge, the platform defining a flow path, for the payload and a first fluid, extending from the inlet wall to the outlet edge, the base comprising one or more projections extending upward into the flow path, the projections configured to create a disturbance in fluid flow that imparts a rotation force upon the payload as the payload is conducted toward the outlet edge; and a bath that receives the payload after the payload is conducted beyond the outlet edge, the bath comprising a second fluid that, when combined with the first fluid, forms a polymer coating around the payload. The payload may comprise a food product. The first fluid may comprise alginate. The second fluid may comprise calcium. One or more fluid sources may be positioned above the enrobing platform that are configured to form one or more fluid curtains of the first fluid that extend transversely relative to the flow path. The one or more fluid curtains may be configured to coat a top portion of the payload as the payload is conducted by the first fluid along the flow path and under the fluid curtains. The one or more projections may comprise a plurality of elongate protrusions extending in a direction transverse to a flow path direction. The plurality of elongate protrusions may extend transversely substantially entirely across the flow path. The one or more projections may comprise a front ramp on a portion closest to the inlet wall, the front ramp comprising an oblique transition from a base plane to a point on the one or more projections that is above the base plane. The one or more projections may comprise a plurality of discontinuous protrusions extending upward from a base plane. The base may be inclined from the inlet wall toward the outlet edge. A transition portion between the outlet edge of the enrobing platform and the bath may be provided, the transition portion suspending the payload, such that excess alginate is drained from the payload prior to placing the payload in the bath. The bath may be configured to conduct the payload in the second fluid in a bathing path direction from a first end portion of the bath toward a second end portion of the bath, opposite the first end portion. The bath may comprise a plurality of fingers that extend into the second fluid and move from the first end portion toward the second end portion. The plurality of fingers may be configured to guide the payload through the bath toward the second end portion. The plurality of fingers may be positioned on an elongate arm positioned transversely to the bathing path direction. The elongate arm may be configured to be conveyed in the bathing path direction from the first end portion toward the second end portion. The elongate arm may be conveyed by a conveyer belt positioned above the bath. The plurality of fingers may be configured to lift the payload out of the bath at the second end portion. The bath may comprise a plurality of injection jets positioned between the first end portion and the second end portion, the plurality of injection jets configured to inject the second fluid into the bath to create turbulent fluid flow within the bath. At least one of the plurality of injection jets may be positioned at the first end portion and is directed upward from a base of the bath.

Some embodiments provide a system for coating a payload, comprising: an enrobing platform having a base, an inlet wall, two opposing side walls, and an outlet edge, the platform defining a flow path, for the payload and a fluid, extending from the inlet wall to the outlet edge; and a reservoir above the enrobing platform for holding the fluid and, in use, directing the fluid to form a plurality of fluid curtains extending transversely relative to the flow path, the plurality of fluid curtains configured to coat a top portion of the payload as the payload is conducted by the fluid along the flow path and under the plurality of fluid curtains. The payload may comprise a food product. The fluid may comprise alginate. The plurality of fluid curtains may be configured to provide a first shear force on the top portion of the payload that is different than a second shear force on a bottom portion of the payload as the payload is conducted through the plurality of fluid curtains, such that the first and second shear forces acting on the payload cause the payload to rotate. The first shear force may be imparted by a vertical force of the plurality of fluid curtains flowing onto a front portion of the payload. The plurality of fluid curtains may comprise three fluid curtains. The base may be inclined from the inlet portion to the outlet portion.

Certain embodiments herein provide a system for coating a payload with a fluid, comprising: an enrobing platform having a base, an inlet wall, two opposing side walls, and an outlet edge, the platform defining a flow path, for the payload and the fluid, extending from the inlet wall to the outlet edge; a top reservoir above the enrobing platform for holding the fluid and, in use, directing the fluid to form a curtain of fluid along the flow path, the curtain of fluid configured to cover a payload with the fluid as the payload is conducted along the flow path; a bottom reservoir beneath the enrobing platform configured to capture fluid discharged from the enrobing platform; and a pump that directs fluid from the bottom reservoir to the top reservoir.

Certain methods discussed herein for coating a payload, include the steps of: providing an enrobing platform having a base, an inlet wall, two opposing side walls, and an outlet edge; directing a fluid to be introduced onto the enrobing platform such that the fluid flows along a flow path having a direction from the inlet wall toward the outlet edge; directing the payload to the enrobing platform and conducting the payload along the flow path by the flow of the fluid; and rotating the payload by forming a disturbance in the fluid, such that the payload is rotated without directly contacting the enrobing platform. The payload may comprise a food product. The fluid may comprise alginate. The disturbance in the fluid may be created by providing on the base one or more projections extending upward into the flow path. The disturbance in the fluid may be created by pouring the fluid from a position above the enrobing platform to form one or more fluid curtains that extend transversely relative to the flow path direction. The one or more fluid curtains may be configured to provide a first shear force on the top portion of the payload that is different than a second shear force on a bottom portion of the payload as the payload is conducted through one or the one or more fluid curtains, such that the first and second shear forces acting on the payload cause the payload to rotate. The first shear force may be imparted by a vertical force of the fluid curtain flowing onto a front portion of the payload. The one or more fluid curtains may comprise three fluid curtains.

Some methods described herein for coating a payload, include the steps of: providing an enrobing platform having a base, an inlet wall, two opposing side walls, and an outlet edge; directing a fluid to be introduced onto the enrobing platform such that the fluid flows along a flow path having a direction from the inlet wall toward the outlet edge; directing the payload to the enrobing platform and conducting the payload along the flow path by the flow of the fluid; and pouring the fluid from a position above the enrobing platform to (i) form one or more fluid curtains that extend transversely relative to the flow path direction and (ii) coat a top portion of the payload as the payload is conducted through one of the one or more fluid curtains. The payload may comprise a food product. The fluid may comprise alginate. The method may further include the step of providing a disturbance in the fluid by providing one or more projections extending upward into the flow path from a base of the enrobing platform. The one or more fluid curtains may be configured to provide a first shear force on the top portion of the payload that is different than a second shear force on a bottom portion of the payload as the payload is conducted through the one or more fluid curtain, such that the first and second shear forces acting on the payload cause the payload to rotate. The first shear force may be imparted by a vertical force of the one or more fluid curtains flowing onto a front portion of the payload. The one or more fluid curtains may comprise three fluid curtains.

Some embodiments described herein include an enrober for coating a payload with a fluid, comprising: a reservoir configured to receive coating material and the payload; an enclosed enrobing channel, fluidly coupled to the reservoir, configured (i) to receive the coating material and the payload from the reservoir and (ii) to conduct the coating material and the payload to an enclosed enrobing channel outlet; wherein when a payload is introduced in the reservoir, flow of the coating material conducts the payload from the reservoir through the enclosed enrobing channel prior to discharge of the payload from the enclosed enrobing channel outlet. The reservoir may be configured for vortex formation in the flow of the coating material at the inlet of the enclosed enrobing channel. The reservoir may be configured to receive the payload adjacent to the inlet of the enclosed enrobing channel. The reservoir may receive coating material at an inlet portion of the reservoir, distal to the inlet of the enclosed enrobing channel. The reservoir may include a bypass flow channel that limits a depth of coating material in the reservoir by discharging excess coating material through the bypass flow channel when the coating material exceeds a pre-determined depth. The enclosed enrobing channel may include a maximum internal cross-sectional dimension that is between about 4 and 1.1 times a payload maximum outer cross-sectional dimension. The enrober may also include a curtain channel that is configured to conduct coating material proximal to the enclosed enrobing channel outlet. The curtain channel outlet may be configured to form a curtain of coating material proximal to the outlet of the enclosed enrobing channel, the curtain having a diameter about the same as an enclosed enrobing channel diameter. The curtain channel outlet may be configured to conduct coating material across the outlet of the enclosed enrobing channel. The curtain channel may be located such that coating material discharged from the curtain channel outlet is configured to fall on the enclosed enrobing channel near the enclosed enrobing channel outlet to form a curtain of coating material across the enclosed enrobing channel outlet. The curtain may include a cross-sectional thickness less than a cross-sectional thickness of the coating material when it is discharged from the curtain channel outlet. In some embodiments, the payload comprises a food product. The fluid may include a hydrocolloid. In some embodiments, the enrober may also include one or more payload sources positioned above the reservoir that are configured to deliver the payload to the reservoir.

Some embodiments described herein include a system for coating a payload, comprising: an enrober having a reservoir configured to receive coating material and the payload, an enclosed enrobing channel, fluidly coupled to the reservoir, configured (i) to receive the coating material and the payload from the reservoir and (ii) to conduct the coating material and the payload to an enclosed enrobing channel outlet; and a bath that receives the payload after the payload is conducted beyond the enrober outlet, the bath comprising a second fluid that, when contacting the coating material, forms a polymer coating around the payload. In some embodiments, the reservoir may be configured for vortex formation in the flow of the coating material at the inlet of the enclosed enrobing channel. The reservoir may be configured to receive the payload adjacent to the inlet of the enclosed enrobing channel. The reservoir may receive coating material at an inlet portion of the reservoir, distal to the inlet of the enclosed enrobing channel. The reservoir may include a bypass flow channel that limits a depth of coating material in the reservoir by discharging excess coating material through the bypass flow channel when the coating material exceeds a pre-determined depth. The enclosed enrobing channel may include a maximum internal cross-sectional dimension that is between about 4 and 1.1 times a payload maximum outer cross-sectional dimension. The system may also include a curtain channel that is configured to conduct coating material proximal to the enclosed enrobing channel outlet. A curtain channel outlet may be configured to form a curtain of coating material proximal to the outlet of the enclosed enrobing channel, the curtain having a diameter about the same as an enclosed enrobing channel diameter. The curtain channel outlet is configured to conduct coating material across the outlet of the enclosed enrobing channel. The curtain channel outlet may be located such that coating material discharged from the curtain channel outlet is configured to fall on the enclosed enrobing channel near the enclosed enrobing channel outlet to form a curtain of coating material across the enclosed enrobing channel outlet. The curtain may include a cross-sectional thickness less than a cross-sectional thickness of the coating material when it is discharged from the curtain channel outlet.

A method for coating a payload described herein may include providing an enrobing reservoir having a reservoir outlet; directing a coating material into the reservoir such that the fluid flows within the reservoir toward the reservoir outlet; directing the payload to the reservoir and depositing the payload in the reservoir adjacent to the reservoir outlet; and conducting the payload through the reservoir outlet within an enclosed enrobing channel to be discharged at an enclosed enrobing channel outlet. The method may further include forming a vortex flow within the coating material in the reservoir at the reservoir outlet. The payload may be delivered into the vortex flow within the coating material. The coating material may be deposited into the reservoir at a portion distal to the reservoir outlet. A depth of the coating material within the reservoir may be limited by discharging excess coating material through a bypass flow channel when the coating material exceeds a pre-determined depth. The method may further include forming a curtain of coating material across the enclosed enrobing channel outlet. The curtain may be formed by discharging coating material from a curtain channel onto the enclosed enrobing channel proximal to the enclosed enrobing channel outlet. The payload may include a food product. The fluid may include hydrocolloid.

Some embodiments herein provide a system for providing a polymer coating on a payload, including: a bath configured to receive a payload coated with a first fluid, the bath comprising a second fluid that, when combined with the first fluid, forms a polymer coating around the payload; and a plurality of fingers that extend into the second fluid and are configured to conduct the payload in the second fluid in a bathing path direction from a first end portion of the bath toward a second end portion of the bath, opposite the first end portion. The payload may comprise a food product. The first fluid may comprise alginate. The second fluid may comprise calcium. The plurality of fingers may be positioned on an elongate arm positioned transversely to the bathing path direction. The elongate arm may be configured to be conveyed in the bathing path direction from the first end portion toward the second end portion. The elongate arm may be conveyed by a chain belt positioned above the bath. The plurality of fingers may be configured to lift the payload out of the bath at the second end portion. The bath may comprise a plurality of injection jets positioned between the first end portion and the second end portion, the plurality of injection jets configured to inject the second fluid into the bath to create turbulent fluid flow within the bath. The turbulent fluid flow may be configured to rotate the payload within the bath. At least one of the plurality of injection jets may be positioned at the first end portion and be directed upward from a base of the bath. The bath may be configured to conduct the payload through the bath in about two minutes.

Certain embodiments described herein provide a system for providing a polymer coating on a payload, comprising: a bath configured to receive a payload coated with a first fluid, the bath comprising a second fluid that, when combined with the first fluid, forms a polymer coating around the payload; and a plurality of fingers that extend into the second fluid and are configured to conduct the payload along a portion of bath in the second fluid in a bathing path direction from a first end portion of the bath toward a second end portion of the bath, opposite the first end portion. The plurality of fingers may be configured to conduct the payload through the bath in about two minutes. The payload may comprise a food product. The first fluid may comprise alginate. The second fluid may comprise calcium. The plurality of fingers may be positioned in rows that are about 90° apart from adjacent rows of the plurality of fingers on a rotating cylinder positioned transversely to the bathing path direction. The rotating cylinder may be driven by a chain drive. The plurality of fingers may be interlaced with plurality of fingers on one or more adjacent rotating cylinders. A plurality of fingers may be configured to lift the payload out of the bath at the second end portion. The bath may further include a plurality of injection jets positioned between the first end portion and the second end portion, the plurality of injection jets configured to inject the second fluid into the bath to create turbulent fluid flow within the bath. The turbulent fluid flow may be configured to rotate the payload within the bath. At least one of the plurality of injection jets may be positioned at the first end portion and is directed upward from a base of the bath.

Some methods described herein for forming a payload, include the steps of: providing an injection mold comprising (i) a first portion having a first coupling edge and an aperture for receiving material within the mold, and (ii) a second portion having a second coupling edge that is configured to couple with the first coupling edge; precooling the injection mold; coupling the first portion with the second portion along the first and second coupling edges such that a cavity is formed within the first and second portions; injecting a fluid into the cavity through the aperture; cooling the fluid within the cavity to a temperature at or below a threshold cooling temperature to form the payload; and releasing the payload from the injection mold by separating the first and second portions. The cooling the fluid may comprise circulating glycol through tubes coupled to the injection mold. The cooling the fluid may comprise dipping the injection mold in liquid nitrogen. The fluid may comprise a food product. The method may further include directing fluid away from the cavity, after the injecting a fluid step to release pressure in a supply line that provide the fluid to the cavity.

Systems for encapsulating an edible payload are provided, the systems can include a first fluid source; a second fluid source; and a transfer mechanism, comprising: an elongate member having a first end and a second end, the first end configured to receive the edible payload and to position the edible payload to a first position; and an actuating member, coupled with the second end, configured to move the elongate member to a second position; wherein the first fluid source is configured to encapsulate the payload, while at the first position, with a first fluid, and after the payload is encapsulated in the first fluid, the actuating member is configured to move the elongate member to contact and conduct the encapsulated payload to a second position at the second fluid source, comprising a second fluid, such that the encapsulated payload contacts the second fluid. The first end may be configured to move through the first fluid, within the first fluid source, away from the payload, such that payload separates from the first end. The actuating member may be configured to move the first end through the first fluid at a velocity, based on a viscosity of the first fluid, such that the payload follows the first end through the first fluid while separated from the first end. The actuating member may be configured to submerge the first end in the first fluid before the first end receives the payload. The actuating member may be configured to submerge the first end and the payload in the first fluid after the first end receives the payload. The actuating member may be configured to submerge the first end in the first fluid when the first end receives the payload. The actuating member can rotate the elongate member about an axis of rotation from the first position to the second position. The actuating member may be configured to rotate the elongate member about the axis of rotation at least 180°. The axis of rotation may be positioned at the second end of the elongate member. The first end may be configured to receive a liquid payload. The first end can comprise a concave surface with an elevated rim. The first end can include an aperture extending from a top surface to a bottom surface. The first end can include a channel extending from a top surface to a bottom surface. The first end can include a plurality of channels extending from a top surface to a bottom surface. The system can include a plurality of guide rails extending from the first end to the second end that are configured to provide lateral support for the payload as the payload is conducted from the first end toward the second end. The system can include a plurality of support rails, upon which the payload is conducted from the first end toward the second end, the plurality of support rails extending (i) from the first end in a first direction that is substantially parallel to the plurality of guide rails and (ii) in a second direction, substantially transverse to the first direction at an intermediate position between the first end and the second end. The elongate member may include a semi-cylindrical channel extending from the first end toward the second end. The channel may include a longitudinally extending opening. The longitudinally extending opening can have an increasing maximum cross-sectional dimension as the opening extends from the first end toward the second end. The channel can include an enlarged aperture, having a maximum cross-sectional dimension greater that the longitudinally extending opening maximum cross-sectional dimension, at an end of the longitudinally extending opening closest to the second end. The system can provide that the payload comprises a food product, and the first fluid can include alginate. The second fluid can include calcium.

Methods for encapsulating an edible payload can include receiving an edible payload at a first end of an elongate member when the elongate member is at a first position; moving the elongate member such that the payload is encapsulated in a first fluid of a first fluid source; after the payload is encapsulated with the first fluid, moving the elongate member to contact and conduct the encapsulated payload toward a second position; straining the payload while the elongate member is moved to the second position, such that excess of the first fluid is removed from the payload; and depositing the payload from the elongate member, at the second position, in a second fluid at a second fluid source. The first end can be moved through the first fluid, within the first fluid source, away from the payload, such that payload separates from the first end. The first end can be moved through the first fluid at a velocity, based on a viscosity of the first fluid, such that the payload follows the first end through the first fluid while separated from the first end. The first end can be submerged in the first fluid before the first end receives the payload. The first end and the payload can be submerged in the first fluid after the first end receives the payload. The first end may be submerged in the first fluid when the first end receives the payload. When the elongate member is in the first position, the first end can be submerged in the first fluid source. The elongate member may be rotated from the first position to the second position. The elongate member may be rotated about an axis of rotation at a second end of the elongate member, opposite the first end. The elongate member may be rotated about the axis of rotation at least 180°. The payload may comprises a liquid payload. The payload may be moved at the first end in a concave surface with an elevated rim. The first end can include an aperture extending from a top surface to a bottom surface. The first end can include a channel extending from a top surface to a bottom surface. The first end can include a plurality of channels extending from a top surface to a bottom surface. The payload may be moved along a plurality of guide rails, extending from the first end to a second end of the elongate member, that are configured to provide lateral support for the payload as the payload is conducted from the first end toward the second fluid source. The payload may be conducted along a plurality of support rails from the first end toward the second end, the plurality of support rails extending (i) from the first end in a first direction that is substantially parallel to the plurality of guide rails and (ii) in a second direction, substantially transverse to the first direction at an intermediate position between the first end and the second end. The elongate member may include a semi-cylindrical channel extending from the first end toward a second end. The channel may include a longitudinally extending opening. The longitudinally extending opening may include an increasing maximum cross-sectional dimension as the opening extends from the first end toward the second end. The first end may further include an enlarged aperture, having a maximum cross-sectional dimension greater that the longitudinally extending opening maximum cross-sectional dimension, at an end of the longitudinally extending opening closest to the second end. The payload comprises a food product. The first fluid may include alginate. The second fluid may include calcium.

Some enrobers, for coating a payload with a fluid, include: a reservoir configured to receive coating material and the payload; a plurality of enrobing channels, fluidly coupled to the reservoir, configured (i) to receive the coating material and the payload from the reservoir and (ii) to conduct the coating material and the payload to an enrober outlet; wherein when a payload is introduced in the reservoir, flow of the coating material conducts the payload from the reservoir through each of the plurality of enrobing channels prior to discharge of the payload from the enrober at the enrober outlet.

Some methods for coating a payload include: providing an enrobing reservoir having a plurality of reservoir outlets; directing a coating material to be introduced into the reservoir such that the fluid flows within the reservoir toward the reservoir outlets; directing the payload to the reservoir and depositing the payload in the reservoir at one of the reservoir outlets; and conducting the payload through the respective reservoir outlet within one of a plurality of enrobing channels to be discharged at an enrobing channel outlet.

Certain methods described herein for rinsing a payload, include the steps of: providing a payload coated that has been treated with a polymerization process to form a polymerized alginate coating; washing the coated payload with water to remove byproducts of the polymerization process from a surface of the coating; and directing air over the coated payload to remove and evaporate water from the surface. The washing may comprise passing the payload through a bath of water. The washing may comprise passing the payload under a shower of water. The directing air over the coated payload may comprise directing air at a pressure less than about 60 psi.

It is to be understood that both the foregoing general description and the following detailed description are exemplary and explanatory and are intended to provide further explanation of the subject technology.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates a perspective view of a payload molding subsystem according to certain aspects of the present disclosure.

FIGS. 2A-2C depict views of a payload mold according to certain aspects of the present disclosure.

FIG. 3 depicts a view of the payload injector according to certain embodiments of the present disclosure.

FIG. 4 depicts a view of a payload ramp according to certain embodiments of the present disclosure.

FIG. 5 is a side view of an enrobing platform according to certain embodiments of the present disclosure.

FIG. 6 is a front side view of an enrobing platform according to certain embodiments of the present disclosure.

FIG. 7 is a rear side view of an enrobing platform according to certain embodiments of the present disclosure.

FIG. 8 is a side view of an enrobing platform during operation according to certain embodiments of the present disclosure.

FIG. 9 is a side view of an enrobing platform during operation according to certain embodiments of the present disclosure.

FIG. 10 is a side view of a transition between the enrobing platform and a bath according to certain embodiments of the present disclosure.

FIG. 11 depicts a front portion of a bath according to certain embodiments of the present disclosure.

FIG. 12 depicts a side view of a bath according to certain embodiments of the present disclosure.

FIG. 13 is a front side view of a washing subsystem according to certain embodiments of the present disclosure.

FIG. 14 is a rear side view of the washing subsystem according to certain embodiments of the present disclosure.

FIG. 15 depicts a front perspective view of an enrobing system during operation according to certain embodiments of the present disclosure.

FIG. 16 depicts a top perspective view of an enrobing system reservoir during operation according to certain embodiments of the present disclosure.

FIG. 17 depicts a side view of portions of an enrobing system during operation according to certain embodiments of the present disclosure.

FIG. 18 depicts a close-up front perspective view of a portion of an enrobing system during operation according to certain embodiments of the present disclosure.

FIG. 19 depicts a side view of a coating system according to certain embodiments of the present disclosure.

FIG. 20 depicts a perspective view of a coating system according to certain embodiments of the present disclosure.

FIG. 21 depicts a perspective view of modular components of a coating system according to certain embodiments of the present disclosure

FIGS. 22A-22F depict schematic images reflecting a transfer of material according to certain embodiments of the present disclosure.

FIG. 23 depicts schematic images reflecting a transfer of material according to certain embodiments of the present disclosure.

FIG. 24 depicts a transfer mechanism for transfer of material according to certain embodiments of the present disclosure.

FIG. 25 depicts a transfer mechanism for transfer of material according to certain embodiments of the present disclosure.

FIGS. 26A-26G depict embodiments of a transfer mechanism for transfer of material according to certain embodiments of the present disclosure.

### DETAILED DESCRIPTION

In the following detailed description, numerous specific details are set forth to provide a full understanding of the present disclosure. It will be apparent, however, to one ordinarily skilled in the art that embodiments of the present disclosure may be practiced without some of the specific details. In other instances, well-known structures and techniques have not been shown in detail so as not to obscure the disclosure. In the referenced drawings, like numbered elements are the same or essentially similar. Reference numbers may have letter suffixes appended to indicate separate instances of a common element while being referred to generically by the same number without a suffix letter.

While the discussion herein is provided primarily in the context of coating food product with a membrane, the disclosed concepts and methods may be applied to other fields that would also benefit from the principles discussed herein. For example, other materials may be used with the systems and methods described herein to produce products encased in a membrane.

As used herein, the term “payload” is meant to have its plain and ordinary meaning, which includes, without limitation, the material that is molded and then coated. By way of example only, the payload may refer to a molded sphere of ice cream or yogurt that is later coated by the processes described herein. In another embodiment, the payload can be a coated food product that is subjected to one or more coating and/or polymerization processes.

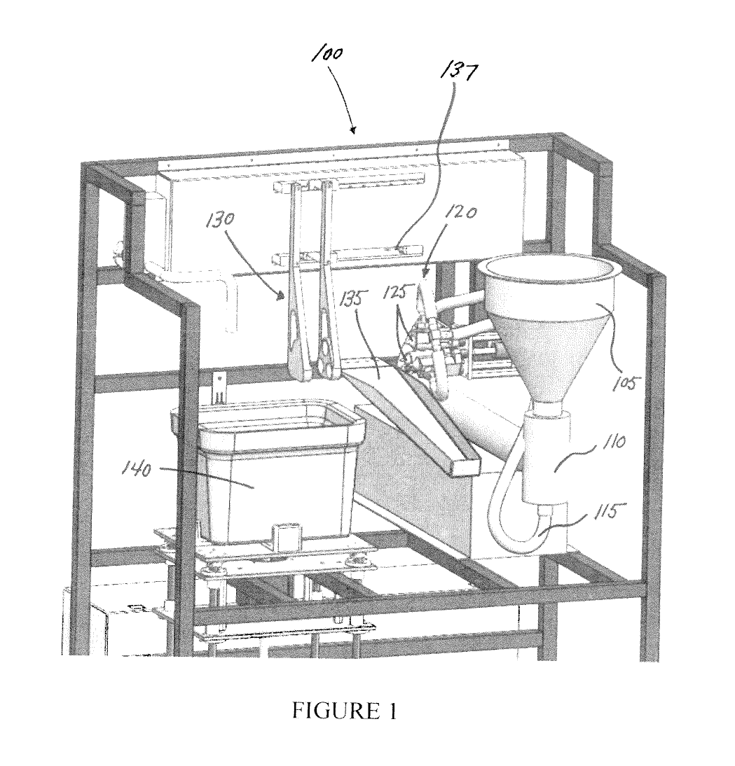

FIG. 1 illustrates a perspective view of a payload molding subsystem 100. The subsystem 100 can include a hopper 105 that receives material and then directs the material into a pump 110. The pump 110 directs the payload material through an injection line 115 that is coupled on one end to the pump 110 and on the other end to an injection assembly 120. The injection assembly 120 can include one or more injection nozzles 125 that are configured to inject the payload material into a mold cavity, such as mold cavity 168 discussed herein.

The molding subsystem 100 can include molding arms 130 that, when coupled together, form a cavity 168 into which the payload material is injected. After the payload material is formed within the molding arms 130, it may be released by separating the molding arms 130 and dropped into a ramp 135. The molding arms 130 can be mounted on a rack 137 along which the molding arms 130 can be moved between a first position for receiving the payload material from the injection nozzles 125 and a second position for dropping the molded payload material onto the ramp 135.

The molding subsystem 100 may include a cooling bath 140 into which a portion of the molding arms are inserted. In some embodiments, the cooling bath 140 may include a liquid that pre-cools the molding arms 130 prior to the payload material being injected into the cavities 168. For example, the cooling bath 140 may be filled with liquid nitrogen, and the molding arms 130 can be submersed in the liquid nitrogen until a desired temperature of the molding arms 130 is reached. In other embodiments, the molding arms 130 can be cooled by other cooling means. For example, the molding arms 130 can be cooled by glycol cooling tubes (not shown) that circulate glycol to reduce the temperature of the molding arms 130.

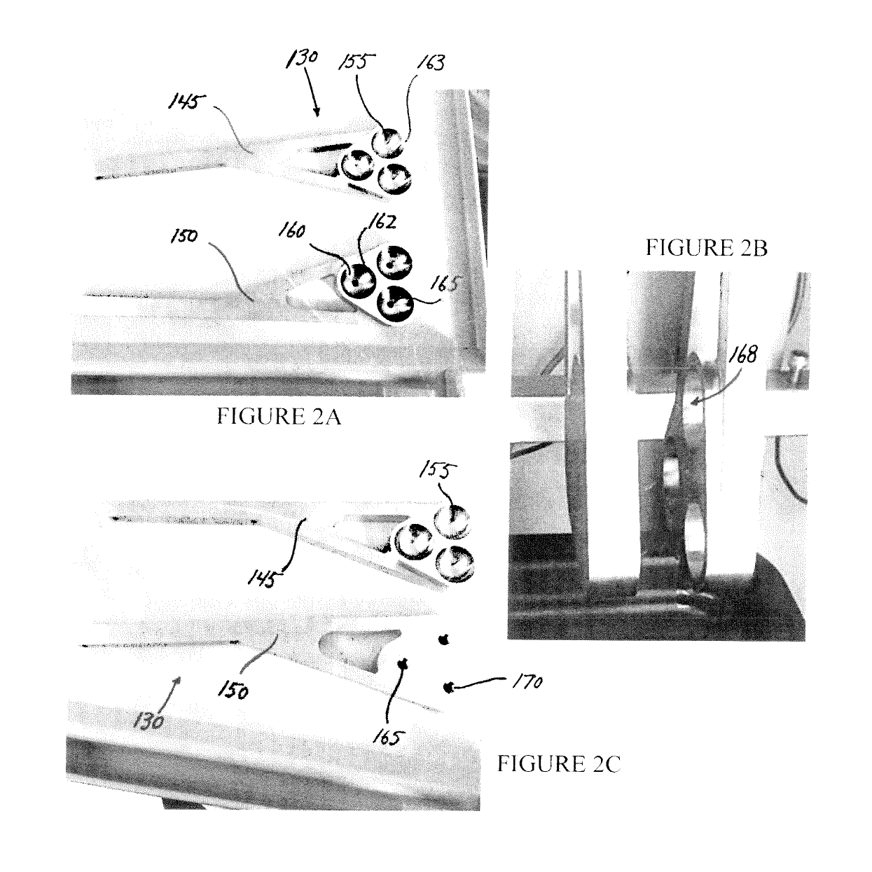

FIGS. 2A-2C illustrate views of exemplary molding arms 130. The molding arms 130 can include an enclosed mold arm 145 and an injection mold arm 150. The enclosed mold arm 145 preferably includes one or more mold recesses 155. The injection mold arm 150 preferably includes one or more injection recesses 160 such that when the injection mold arm 150 and the enclosed mold arm 145 are coupled together, the one or more mold recesses 155 and the one or more injection recesses 160 are aligned and form a cavity 168, as is about to be formed in FIG. 2B if the arms 145, 150 are drawn together.

FIG. 2C illustrates the enclosed mold arm 145 and the one or more mold recesses 155 and a back view of the injection mold arm 150. The back view of the injection mold arm 150 depicts injection apertures 165, which when viewed with FIG. 2A, can be shown as extending through the injection mold arm 150. FIG. 2A illustrates these injection apertures 165 as being positioned at a base of the one or more injection recesses 160, but the injection apertures 165 can be positioned in other places within the one or more injection recesses 160 or along the injection mold arm 150. FIG. 2C illustrates a bevel 170 around the injection apertures 165. The bevel 170 is configured to increase surface area contact between the injection apertures 165 and the injection nozzles 125.

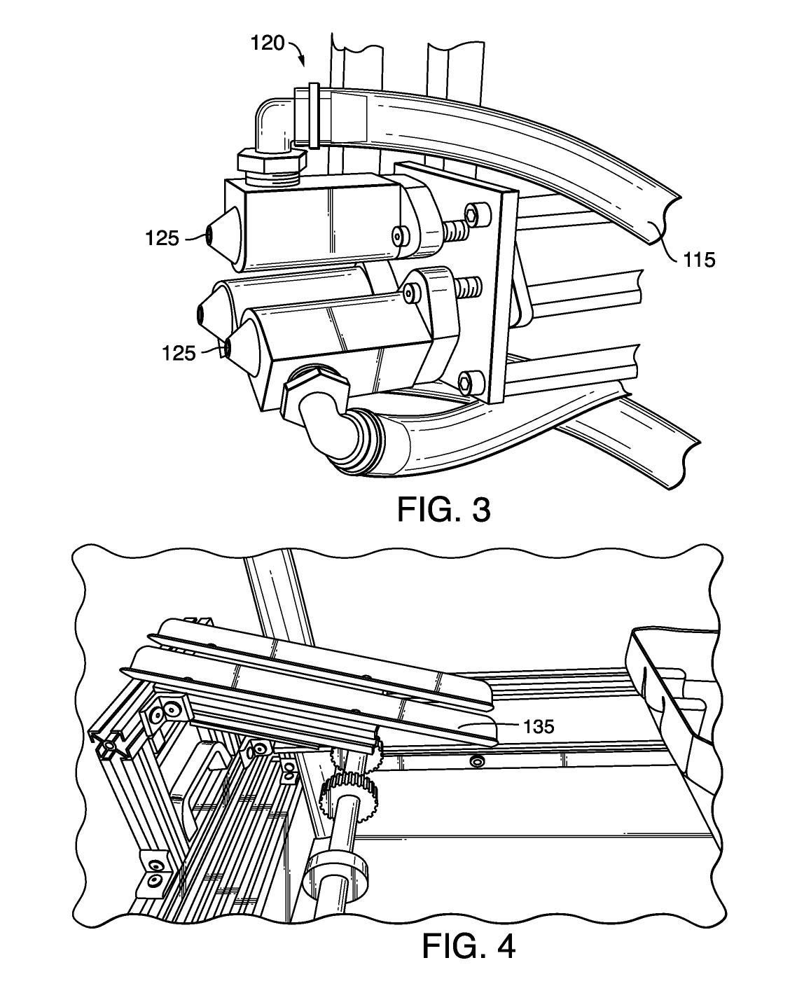

FIG. 3 illustrates the injection assembly 120 which may include a plurality of injection nozzles 125. The payload material is directed toward the injection nozzles 125 through an injection line 115. The injection assembly 120 can also include a pressure release (not shown) that permits payload material forced into the injection assembly 120 to be discharged in a line that directs the excess payload material back to the hopper 105 when a pressure within the injection assembly 120 exceeds a determined level. During injection of the payload material into the mold, the payload material will change temperature, which can, in some instances, cause expansion of the material. The pressure release can include an aperture that conducts fluid to a release line upon expansion of the material. The pressure release provides an automatic check system that enables the injection assembly 120 to accommodate different materials at different pressures and different temperatures. As can be seen in FIG. 3, the injection nozzles 125 have a frustoconical shape with a sloping angle that preferably matches the bevel 170 on the injection mold arm 150. The matching angles increase the surface area contact between the bevel 170 and the nozzles 125 to reduce the likelihood of leakage during injection of the payload material.

FIG. 4 illustrates another embodiment of a ramp 135 that is oriented and designed to receive the molded payload from the molding arms 130. The ramp 135 can be oriented at a downward angle, such that the molded payload can roll or slide down the ramp 135.

In operation, the payload molding subsystem 100 receives the payload material, directs the payload material into a mold, where the payload material is frozen, and the mold releases the molded payload onto a ramp that directs the molded payload toward coating subsystems. Methods for forming a molded payload include the step of providing an injection mold (e.g., the molding arms 130), having a first portion (e.g., the injection mold arm 150) having a first coupling edge 162 that forms the one or more injection recesses 160 and injection apertures 165 for receiving the payload material injection recesses 160, a second portion (e.g., the enclosed mold arm 145) having a second coupling edge 163 that forms the one or more mold recesses 155, and the injection mold arm 150 and the enclosed mold arm 145 are configured to couple together.

The injection assembly 120 can include a central rod (not shown) that extends to or through the nozzles 125. In this configuration, the central rod operates to close or seal the nozzles 125 such that the payload material is unable to be discharged through the nozzles 125. The central rod can be retracted inward to create an opening at the nozzles 125, thereby permitting injection of the payload material through the nozzles 125. In some embodiments, the central rod can be actuated to extend out of the nozzles 125 and can be used to dislodge a molded payload when the molded payload does not drop from the molding arms 130 after the molding arms are separated. For example, the central rod can be advanced toward the molding arms 130 beyond the nozzles 125 such that the central rod extends through the injection aperture 165 and contacts the molded payload.

The molding arms 130 may be vibrated at a frequency (e.g., from 5 Hz to about 50 Hz, and preferably about 20 Hz) while the payload material is being injected into the cavity 168. Vibrating the molding arms during the injection process can assist in uniformly distributing the payload material within the cavity 168. The molding arms 130 may also be vibrated just before the molding arms 130 are separated to assist with dislodging of the molded payload from the molding arms 130 when the molding arms 130 are separated. The molding arms 130 may also be separated and re-coupled sharply one or more times to ensure the payload is dislodged from the mold recesses 155, 160.

The molding arms 130 are precooled prior to receiving the payload material. The injection mold arm 150 and the enclosed mold arm 145 are coupled together such that the one or more injection recesses 160 and the one or more mold recesses 155 are aligned and form one or more cavities 168 each having an opening at a respective injection aperture 165. After the molding arms 130 are coupled together and the molding arms 130 are precooled, the payload material is injected into the one or more cavities 168 through the injection aperture 165. The payload material is cooled within the cavity 168 until the payload material reaches a desired temperature or for a desired period of time.

The payload material may be cooled within the cavity 168 by circulating glycol through tubes (not shown) that are coupled to the molding arms 130. In other embodiments, the payload material may be cooled within the cavity 168 by submersing the payload material and the portion of the molding arms 130 containing the payload material into a liquid, such as liquid nitrogen.

After the payload material reaches the desired temperature or has cooled for a desired period of time, the molding arms 130 are separated, and the molded and frozen payload material is released from the molding arms 130. This is preferably performed above or at the ramp 135 such that the payload is then directed down the ramp 135.

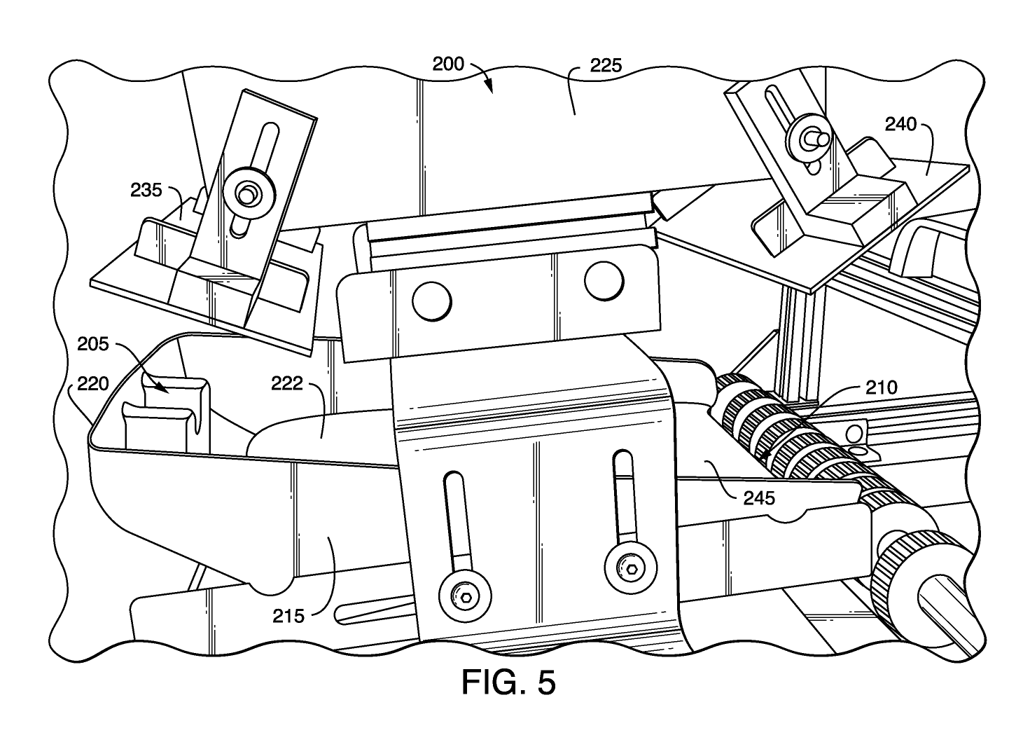

FIG. 5 illustrates a payload enrobing platform 200 that receives the payload from the payload molding subsystem 100 via the ramp 135. The payload enrobing platform 200 is designed to (i) receive the payload in a fluid that is flowing through the payload enrobing platform 200, (ii) conduct the payload along the platform 200 with little or no contact of the payload by a mechanical structure, and (iii) fully coat the payload with the flowing fluid. The fluid flowing along the platform 200 is preferably a fluid that can be polymerized by reacting with a polymerizing agent. For example, in some embodiments, the fluid includes alginate, and the polymerizing agent includes calcium. Accordingly, when the payload is coated with alginate at the platform 200, a polymer coating around the payload can be formed by treating the alginate-coated payload with a calcium polymerizing agent. Various possible combinations of payloads, fluids and polymerizing agents are described in PCT Publications WO/2011/103594 and WO/2013/113027, the entire contents of each being incorporated by reference as if fully set forth herein.

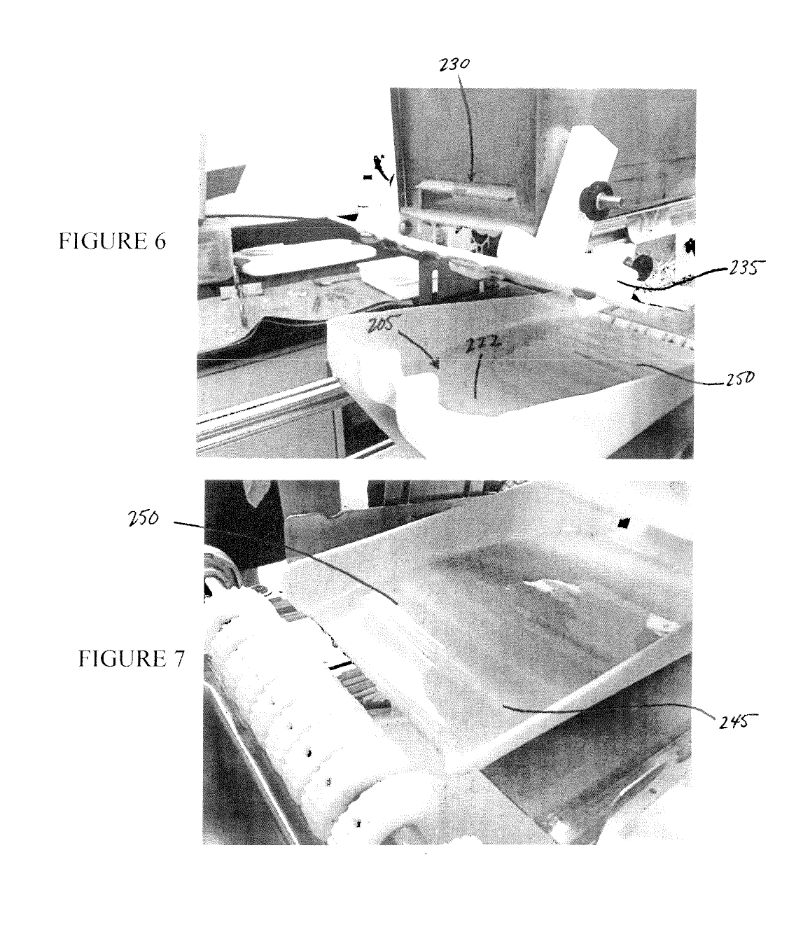

The payload enrobing platform 200 includes an inlet portion 205 on one end and an outlet portion 210 on an opposite end. The platform 200 includes opposing sidewalls 215 and a rear wall 220 at the inlet portion. The outlet portion 210 preferably does not include a wall extending between the sidewalls 215, thereby permitting discharge of the fluid and payload from the platform 200 at the outlet portion 210. The platform 200 includes a base 222 extending between the two sidewalls 215 and from the inlet portion 205 to the outlet portion 210. The platform 200 receives fluid from a fluid source 225, which is illustrated in FIG. 5 as being positioned above the base 222. In the illustrated embodiment, fluid is poured onto the payload platform 200 through openings 230 in the fluid source 225. From the openings 230, the fluid is directed onto the platform 200 by an inlet fluid director 235 or an outlet fluid director 240. FIG. 6 illustrates a front side view of the platform 200, showing the inlet fluid director and one of the openings 230.

The base 222 defines a flow path for the fluid extending from the inlet portion 205 to the outlet portion 210. In some embodiments, the base 222 defines a flat plane along the flow path. In some embodiments, the base 222 defines more than one plane along the platform 200. Adjacent the outlet portion, the base includes one or more projections 245 extending upward into the flow path from a generally uniform plane of the base. The one or more projections 245 are configured such that as fluid is flowing along the platform 200, when the fluid reaches the one or more projections 245, a disturbance or wave 250 (e.g., a stagnant wave) is formed by the one or more projections 245 in the fluid flow.

In the illustrated embodiments of FIGS. 6 and 7, the one or more projections 245 include one or more corrugations that extend substantially an entire width between the two sidewalls 215. In some embodiments, the one or more projections 245 can include a stepwise raise in the contour of the base. In some embodiments, the one or more projections 245 can include a rounded raise in the contour of the base. In some embodiments, the one or more projections 245 can include a ramped raise in the contour of the base. In some embodiments, the ramped raise may include a front ramp on a portion of the one or more projections 245 closest to the inlet portion, and the front ramp can include an oblique transition from a base plane to a point on the one or more projections 245 that is above the base plane. In some embodiments, the one or more projections 245 include a plurality of discontinuous protrusions extending upward from a base plane.

The disturbance or wave 250 creates a variable velocity profile of the fluid over the one or more projections 245. The variable velocity profile has a lower velocity closer to the base 222 and a higher velocity closer to a top surface of the fluid. As the payload is being conducted in the fluid along the flow path, when the payload reaches the disturbance or wave 250, the lower velocity in the variable velocity profile exerts a slowing force on a bottom portion of the payload. While the bottom portion of the payload is being slowed down by the lower velocity, the higher velocity in the variable velocity profile exerts a forward moving force on a top portion of the payload. The different forces acting upon the payload create a tendency of the payload to rotate at the disturbance or wave 250.

Rotation of the payload can further be effected by pouring fluid onto the platform 200 from the inlet flow director 235 or the outlet flow director 240. For example, outlet flow director 240 may receive fluid from the fluid source 225 and direct the fluid onto fluid flowing along the platform 200. In some embodiments, the outlet flow director 240 can be oriented to distribute the fluid in a fluid curtain 255 that extends transversely across the flow path of the fluid and is positioned at or near the one or more projections 245. In some embodiments, the fluid curtain 255 is positioned such that it extends transversely across the flow path of the fluid downstream of the one or more projections 245.

The fluid curtain 255 can assist in rotating the payload at the disturbance or wave 250 by providing a vertical force acting on a front portion of the payload as the payload passes underneath the fluid curtain 255. The vertical force acts on the front portion of the payload, the higher velocity exerts a forward moving force on a top portion of the payload, and the lower velocity exerts a slowing force on a bottom portion of the payload. The different forces acting on the payload create varying shear forces between the top portion of the payload and the bottom portion of the payload and contribute to a moment or torque that imparts a forward rotation of the payload at the disturbance or wave 250 and the fluid curtain 255. Rotation of the payload within the fluid increases the coverage of the fluid on the payload and prepares the payload with the fluid coating to interact with a polymerizing agent in the next subsystem. One or more fluid curtains 255 also increase coverage of the payload with fluid simply directing fluid over the top of the payload that is not already resting in fluid.

Some embodiments provide that the base 222, extending from the inlet portion 205 toward the outlet portion 210, be oriented at a slight incline to increase the fluid velocity between the inlet portion 205 and the outlet portion 210 and prevent stagnation of fluid that is closer to the base 222.

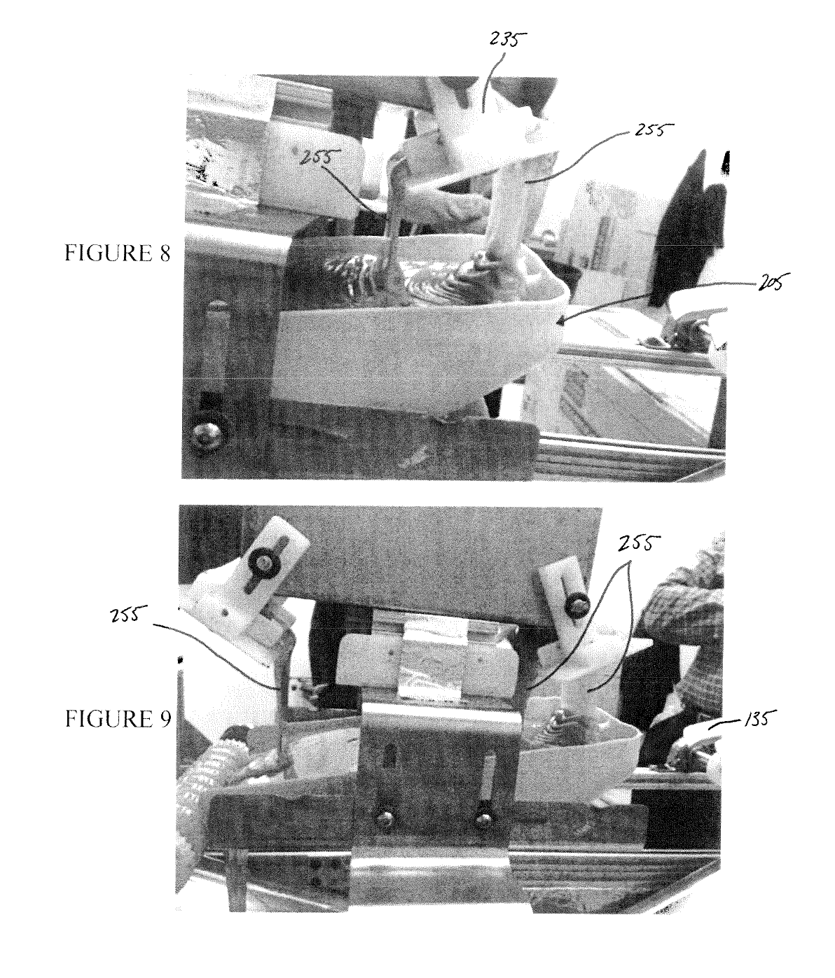

In operation, the fluid source 225 provides the fluid to the platform 200. As illustrated in FIG. 8, toward the inlet portion 205, the inlet fluid director 235 can create two fluid curtains 255 that fill and create flow within the platform 200. In the illustrated embodiment depicting flow of alginate, due to the viscosity of the alginate, a greater amount of fluid is distributed close to the inlet portion 205 in order to create a hydrodynamic force that moves the payload from the inlet portion 205 toward the outlet portion 210. Depending on the viscosity of the fluid that is being poured for downstream fluid curtains 255, the amount of fluid provided close to the inlet portion 205 may need to be adjusted to create adequate fluid flow, such that the payload will be caused to move past the downstream fluid curtains 255. FIG. 9 depicts three fluid curtains 255 that are formed by a single fluid source 225 and the inlet flow director 235 and outlet flow director 240.

Flow of the fluid through the platform 200 and coverage of the payload as it is conducted through the fluid flow is achieved by a number of factors. Among the factors include the viscosity of the fluid, a shape of the one or more projections 245, a flow rate of the fluid along the platform 200, and a mass of the payload. In some embodiments, the viscosity, the shape, the flow rate, and the mass are configured such that the payload will not contact any portion of the enrobing platform as the payload is conducted from the inlet portion 205 to the outlet portion 210.

With the fluid source 225 providing a flow of the fluid through the platform 200, the payload can be introduced to the platform 200. The ramp 135 can be extended over the platform 200 such that the end of the ramp 135 extends through the first fluid curtain 255 that is positioned closest to the inlet portion 205 of the platform 200. The payload is released from the molding arms 130, and the payload is conducted down the ramp 135, through the fluid curtain 255 near the inlet portion 205 and is deposited in the platform 200. In one embodiment, the payload is deposited in the platform 200 by simply falling off of the ramp 135 into the fluid on the platform 200.

In some instances, the payload may be cooled to a temperature that is so cold the payload may require time to adjust its temperature. For example, if a supercooled payload contacts room temperature alginate, the payload may let off gas as the payload warms. In some embodiments, the flow rate of the fluid through the platform 200 is designed to allow the payload to increase in temperature, such that the payload no longer releases gas. The release of gas from the payload may prevent application of a fluid coating or disturb the fluid coating already applied. If the payload is passed through the platform 200 too quickly, the gas released from the payload may jeopardize the integrity of the coating that is formed around the payload. In some embodiments, the fluid flow through the platform 200 is configured to require between about 30 seconds to about 90 seconds for a payload to traverse the platform 200. In some embodiments, the fluid flow through the platform 200 is configured to require from about 25 seconds to about 60 seconds for the payload to traverse the platform 200. In some embodiments, the fluid flow through the platform 200 is configured to require from about 20 seconds to about two minutes. In some embodiments, the fluid flow through the platform 200 is configured to require greater than about two minutes.

The hydrodynamic force of the fluid flow in the platform 200 conducts the payload through any other fluid curtains 255, and the disturbance or wave 250 help to rotate and coat the payload with the fluid. A fluid curtain 255 can be provided just downstream of the disturbance or wave 252 and can further help rotate and coat the payload with the fluid.

As illustrated in FIGS. 5-9, the fluid source 225 can be a reservoir atop the enrobing platform 200. A second reservoir may be provided beneath the enrobing platform that captures fluid discharged from the enrobing platform, which can then be pumped up to the top reservoir by a fluid pump.

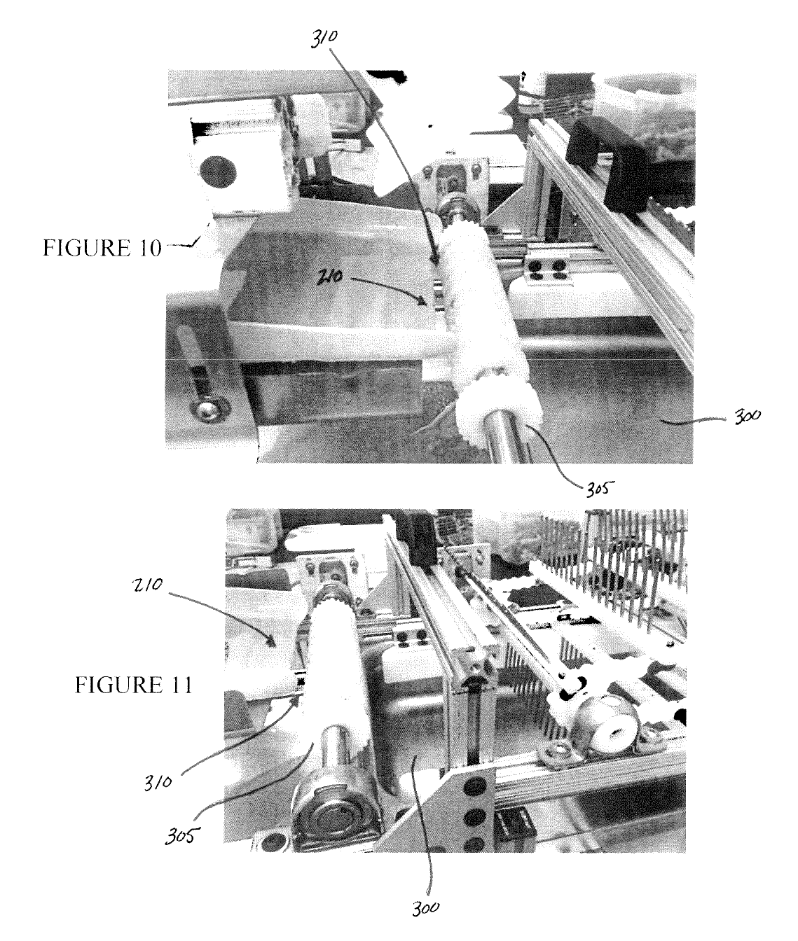

The payload is conducted through the platform 200 to the outlet portion 210, where the payload is discharged from the platform 200 with the excess fluid flowing through the platform 200. After being coated by the fluid in the payload enrobing platform 200, the payload is prepared to be treated with a polymerizing agent in a polymerizing bath 300. A rotating member 305 is positioned as a transition from the outlet portion 210 to the bath 300, such that a gap 310 is provided between the outlet portion 210 of the platform 200 and the rotating member 305, as illustrated in FIGS. 10 and 11.

The gap 310 is preferably sized such that it is smaller than a cross-sectional dimension of the payload. As the payload is discharged from the platform 200 at the outlet portion 210, the payload will be suspended at the gap 310, such that excess fluid (e.g., alginate) is drained from the payload into a reservoir beneath the platform 200. The rotating member 305, which can be gears with spokes, rotates to deposit the fluid-coated payload into the polymerizing bath 300.

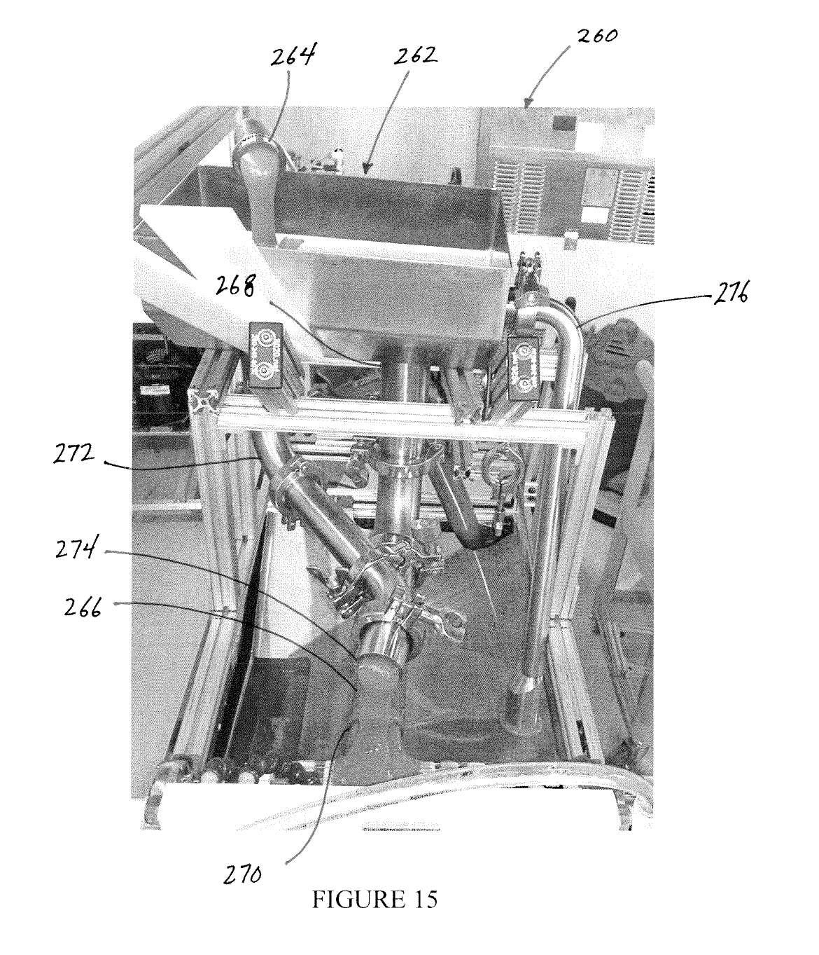

FIGS. 15 through 18 depict embodiments of another enrober 260 for coating the payload. As depicted in FIG. 15, the enrober 260 may include a reservoir 262 that receives fluid at an inlet portion 264 of the reservoir 262. The fluid is conducted by an enclosed enrobing channel 266 that receives the fluid at an inlet 268 of the enclosed enrobing channel 266. The enclosed enrobing channel 266 is fluidly coupled to the reservoir 262 and is configured to conduct the fluid from the inlet 268 toward an enclosed enrobing channel outlet 270. The enrober 260 includes a curtain channel 272 that extends over a portion of the enclosed enrobing channel 266, such that a curtain channel outlet 274 is positioned just proximally of the enclosed enrobing channel outlet 270. The enrober 260 may also include a bypass flow channel 276 that is fluidly coupled to the reservoir 262 and is configured to regulate or control a depth of the fluid within the reservoir 262.

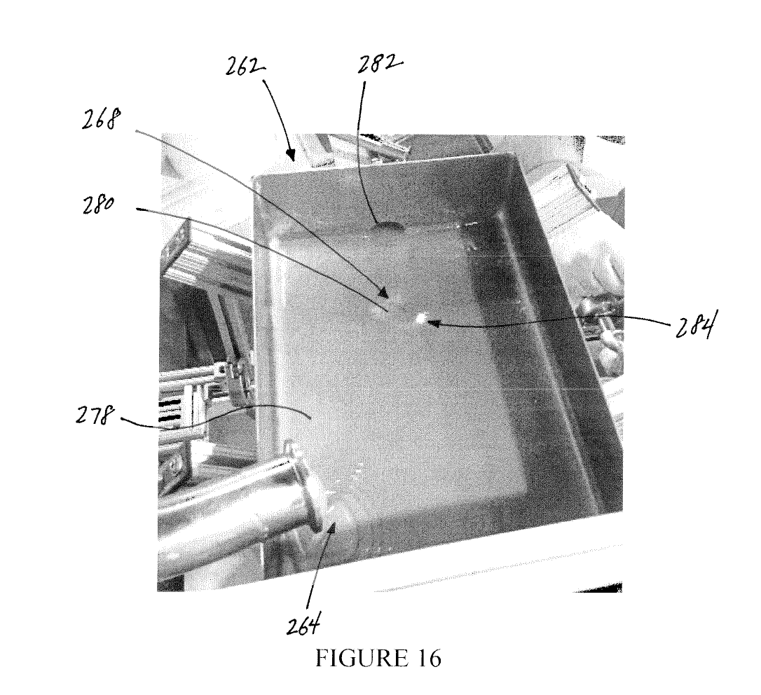

FIG. 16 is a top view of the reservoir 262 of the enrober 260 depicted in FIG. 15. The reservoir 262 is configured to receive fluid at the inlet portion 264 of the reservoir 262, and the fluid is configured to travel across the reservoir toward an inlet of the enclosed enrobing channel 268. As depicted, the inlet portion 264 the reservoir 262 is preferably spaced apart from, and in some instances is on an opposite end of, the enclosed enrobing channel inlet 268. The fluid flow from the inlet portion 264 toward the enclosed enrobing channel in the 268 is preferably a gentle laminar flow.

In the depicted embodiment, the inlet 268 of the enclosed enrobing channel 266 is positioned along a base 278 of the reservoir 262. In some embodiments, the inlet 268 of the enclosed enrobing channel 266 may be positioned along different portions of the reservoir 262. For example, the inlet 268 of the closed enrobing channel 268 may be positioned, in some embodiments, along sidewall portions of the reservoir 262 (not shown).

Also depicted in FIG. 16 is a bypass flow channel inlet 282 that fluidly connects the reservoir 262 with the bypass flow channel 276. The bypass flow channel inlet 282 is preferably positioned at a location above the base 278 of the reservoir 262 such that a depth of the fluid within the reservoir 262 is limited, as excess fluid is received into the bypass flow channel 276 when the fluid within the reservoir 262 reaches a depth that corresponds to the bypass flow channel inlet 282.

The inlet 268 receives the fluid into the enclosed enrobing channel 266, and the enclosed enrobing channel 266 conducts the fluid toward the enclosed enrobing channel outlet 270. The depth of the fluid and the viscosity of the fluid are preferably such that within the reservoir 262 a vortex 280 is formed where the fluid is received into the inlet 268 of the enclosed enrobing channel 266. The vortex 280 preferably creates a dimple or indentation 284 into a top surface of the fluid within the reservoir 262. The indentation 284 in the top surface assists in drawing in the payload when it is deposited into the reservoir 262 at a location adjacent the vortex 280. For example, when the payload is deposited into the reservoir 262 at an edge of the vortex 280, the flow of the fluid into the inlet 268 of the enclosed enrobing channel 266, coupled with the indentation 284 in the top surface of the fluid, will cause the payload to rotate or glide into the inlet 268 of the enclosed enrobing channel 266. As the payload is received into the inlet 268 of the enclosed enrobing channel 266, the payload is fully engulfed in the fluid, and the payload is fully coated with the fluid. In some embodiments, the enrober 260 can include more than one payload source positioned above the reservoir to deliver the payload the reservoir.

As with other embodiments described herein, the fluid flowing through the enrober 260 can be a hydrocolloid. In certain embodiments, the hydrocolloid fluid can be polymerized by reaction with a polymerizing agent. For example, in some embodiments, the fluid includes alginate, and the polymerizing agent includes calcium. When the payload is coated with alginate by the enrobing 260, a polymer coating around the payload can be formed by treating the alginate-coated payload with a calcium polymerizing agent.

A length of the enclosed enrobing channel 266 is preferably selected to achieve objectives described in other embodiments herein. For example, as explained herein, the payload may be cooled to a temperature that is so cold that the payload may require time to adjust its temperature. In such instances, if a supercooled payload contacts room temperature alginate, the payload may let off gas as the payload warms. In some embodiments, the length of the enclosed enrobing channel 266 and the flow rate of the fluid into the inlet 268 of the enclosed enrobing channel 266 and through the enclosed enrobing channel 266 is designed to allow the payload to increase in temperature, such that by the time the payload reaches the enclosed enrobing channel outlet 270, the payload no longer releases gas.

In some embodiments, the fluid flow through the enclosed enrobing channel 266 is configured to require between about 30 seconds to about 90 seconds for a payload to reach the enclosed enrobing channel outlet 270. In some embodiments, the fluid flow through the enclosed enrobing channel 266 is configured to require between about 25 seconds to about 60 seconds for the payload to reach the enclosed enrobing channel outlet 270. In some embodiments, the fluid flow through the enclosed enrobing channel 266 is configured to require from about 10 seconds to about 45 seconds. In some embodiments, the fluid flow through the enclosed enrobing channel 266 is configured to require from about 20 seconds to about two minutes. In some embodiments the fluid flow through the enclosed enrobing channel 266 is configured to require greater than about two minutes.

Hydrodynamic forces move the payload from the enclosed enrobing channel inlet 268 toward the enclosed enrobing channel outlet 270. A number of factors affect the flow of fluid through the enclosed enrobing channel 266 and the coverage of the payload in the fluid as it is conducted toward the outlet 270. Among the factors include the viscosity of the fluid, the depth of the fluid within the reservoir 262, a length of the enclosed enrobing channel 266, a size, or cross-sectional dimension, of the enclosed enrobing channel 266, and a size, or cross-sectional dimension, of the payload. In some embodiments, the enclosed enrobing channel 266 has a maximum internal cross-sectional dimension that is between about 1.1 and about four times a maximum outer cross-sectional dimension of the payload. In some embodiments, the enclosed enrobing channel 266 has a maximum internal cross-sectional dimension that is between about 1.5 and about three times a maximum outer cross-sectional dimension of the payload. In some embodiments, the enclosed enrobing channel 266 has a maximum internal cross-sectional dimension that is between about two and about three times a maximum outer cross-sectional dimension of the payload.

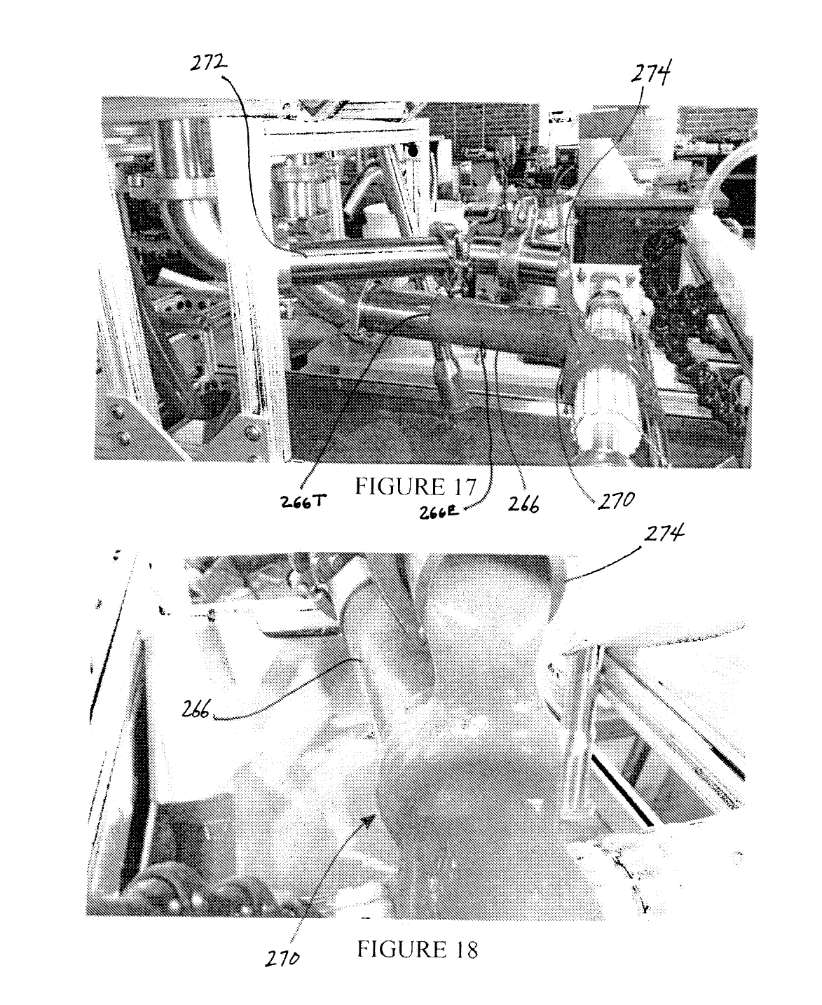

In some aspects, fluid flow from the reservoir 262 through the enclosed enrobing channel 266 to the outlet 270 is modulated to increase or decrease transit time of the fluids/enrobing material and/or the payload through the enclosed enrobing channel 266. In some instances, transit time is controlled by modulating the volume of fluid in the reservoir 262 to increase or decrease fluid pressure in the enclosed enrobing channel 266 and thus flow rate. For example, greater volumes in the reservoir 262 will cause greater fluid pressure in the enclosed enrobing channel 266 and faster transit times through the enclosed enrobing channel 266, and lower volumes in the reservoir 262 will decrease fluid pressure in the enclosed enrobing channel 266 and cause lower transit times. In some embodiments, the enclosed enrobing channel 266 has an attached extension 266E. In certain embodiments the extension attached to the enclosed enrobing channel 266 has an inner diameter smaller than the inner diameter of the enclosed enrobing channel 266. An extension with a smaller inner diameter than the enclosed enrobing channel 266 will create a fluid back pressure in the enclosed enrobing channel 266, and the fluid flow rate through the enclosed enrobing channel 266 will change accordingly. An extension with a smaller inner diameter is therefore another manner of modulating the fluid pressure in and flow rate through the enclosed enrobing channel 266. One example of the extension 266E is depicted in FIG. 17 where a metallic portion of the enclosed enrobing channel 266 terminates at the metallic enclosed enrobing channel terminal end 266T and the extension 266E is shown continuing to the outlet 270. In this depicted embodiment, the outer diameter of the metallic enclosed enrobing channel terminating at terminal end 266T is approximately the same as the outer diameter of the extension 266E. However, in this exemplary embodiment, the extension 266E is inserted into the terminal end 266T of the enclosed enrobing channel 266. Therefore, the internal diameter of the extension 266E is necessarily smaller than the internal diameter than the remainder of the enclosed enrobing channel 266 due to the thickness of the extension 266E. The extension 266E with its reduced internal diameter is one example of modulating the fluid pressure in and flow rate through the enclosed enrobing channel 266.

In some embodiments the volumetric fill of the enclosed enrobing channel is modulated. In certain embodiments, it may be desired that the average volumetric fill of the fluid in the enclosed enrobing channel 266 is approximately equal to the volume of the enclosed enrobing channel 266, approximately 90%, approximately 80%, approximately 70%, approximately 60%, approximately 50%, approximately 40%, approximately 30%, approximately 20% or approximately 10% of the volume of the enclosed enrobing channel 266. In other embodiments, an extension attached to the enclosed enrobing channel 266 modulates the volumetric fill of the enclosed enrobing channel. In certain embodiments, the inner diameter of the extension is configured to create a back flow that modulates the % volumetric fill of the enclosed enrobing channel 266.

Some embodiments may include, as depicted in FIGS. 15-18, a fluid curtain to increase or ensure coverage of the payload with the fluid. FIGS. 17 and 18 depict the curtain channel 272 extending over a portion of the enclosed enrobing channel 266. Fluid may be conducted through the curtain channel 272 and discharged through the curtain channel outlet 274, forming a fluid curtain over the enclosed enrobing channel outlet 270. In some embodiments, the curtain channel outlet is positioned proximal to the enclosed enrobing channel outlet 270. For example, the curtain channel outlet 274 can be positioned such that fluid discharged from the curtain channel outlet 274 is configured to fall on the enclosed enrobing channel 266 near the enclosed enrobing channel outlet 270. In this example, a majority of the coating material discharged from the curtain channel outlet 274 passes about the sides of the enclosed enrobing channel 266, and only a small portion of the coating material discharged from the curtain channel outlet 274 extends over the enclosed enrobing channel outlet 270. Accordingly, the fluid curtain extending over the enclosed enrobing channel outlet 270 can have a cross-sectional thickness that is less than a cross-sectional thickness of the fluid, or coating material, when it is discharged from the curtain channel outlet 274. This can be seen in this embodiment depicted in FIG. 18. In order to achieve this curtain flow, the curtain channel outlet 274 is positioned proximally of the enclosed enrobing channel outlet 270.

As described with other embodiments herein, when the payload passes through the enclosed enrobing channel 266 and is discharged from the enclosed enrobing channel outlet 270, the payload may be conducted to a bath that comprises a second fluid. The second fluid can, in some embodiments, interact with the fluid, or coating material, of enrober 260 to form a polymer coating around the payload.

In operation, methods for operating the enrober 260 can include providing an enrobing reservoir 262 having a reservoir outlet, which, as described herein can be the inlet 268 of the enclosed enrobing channel 266. Coating material is directed into the reservoir 262 such that the fluid flows within the reservoir from the inlet portion 264 of the reservoir 262 toward the reservoir outlet, or enclosed enrobing channel inlet 268. In some embodiments, the inlet portion 264 is distal to, or spaced apart from, which may include being located on an opposite side of the reservoir, the reservoir outlet or enclosed enrobing channel inlet 268.

While the fluid, or coating material, is flowing, the payload is directed to the reservoir 262 and deposited in the reservoir adjacent to the reservoir outlet. As described herein, the flow dynamics within the reservoir 262 are configured to form a vortex flow within the coating material in the reservoir 262 at the reservoir outlet. The payload may be delivered into the vortex flow within the coating material. The payload is then conducted through the reservoir outlet and through the enclosed enrobing channel 266 to be discharged at the enclosed enrobing channel outlet 270.

A depth of the coating material within the reservoir may be limited by discharging excess coating material through bypass flow channel when the coating material exceeds a pre-determined depth. In other embodiments, a pump may be provided instead of the bypass flow channel inlet 282, such that the coating material is pumped out of the reservoir 262 upon predetermined conditions that are triggered to initiate the pump. In other embodiments, an opening and closing aperture may be provided that opens when predetermined conditions are met to begin removal of coating material from the reservoir 262.

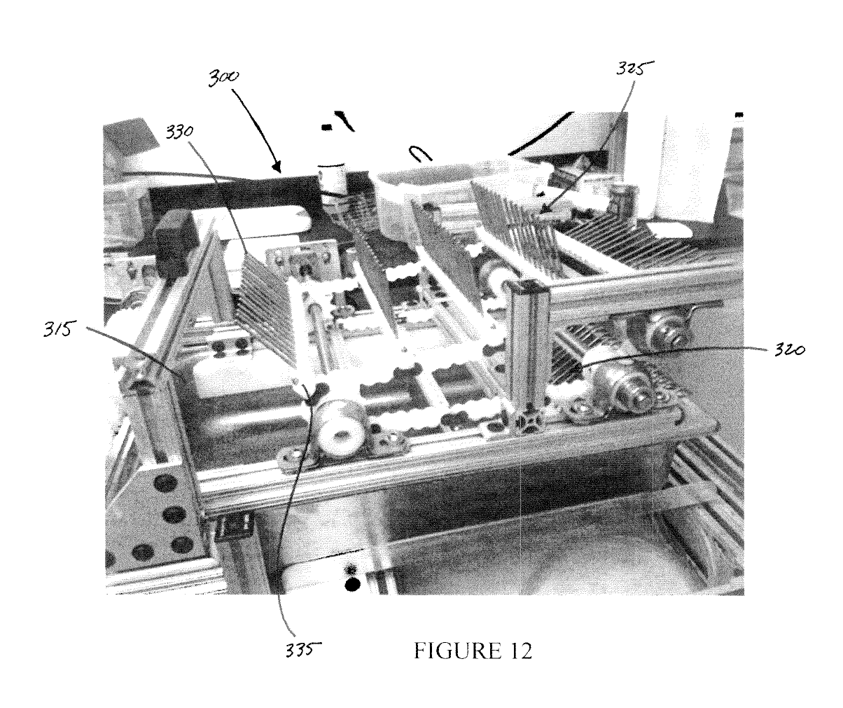

As illustrated in FIG. 12, the polymerizing bath 300 extends from a first end portion 315, positioned adjacent the rotating member 305, to a second end portion 320 opposite the first end portion 315. The bath 300 includes an agent that interacts with the fluid coating of the payload provided during the travel of the payload along the platform 200 to form a polymer coating around the payload.

As the payload with the fluid coating resides in the bath, the fluid and the polymerizing agent interact to polymerize the fluid encapsulating the payload and completely encapsulate the payload with a polymer coating. The polymerizing agent within the bath may be disturbed to create turbulent flow of the agent, which can effect rotation of the payload within the agent to increase exposure of all portions of the fluid coating to the polymerizing agent to more effectively fully polymerize the fluid coating encapsulating the payload. The polymerizing agent may be disturbed by providing fluid jets (not shown) that inject the agent from sidewalls of the bath 300. One or more jets may be provided at the first end portion 315 projecting upward from a base of the bath 300 to create a flow of the agent from the first end portion 315 toward the second end portion 320 so that as the payload is deposited in the bath 300, the payload is conducted toward the second end portion 320 to ensure engagement with an advancement member 325, described herein.

The bath 300 includes advancement members 325 that conduct the payload through the agent from the first end portion 315 toward the second end portion 320 of the bath 300. The advancement members 325 can also operate to slow advancement of the payload through the polymerizing agent to ensure the payload resides in the bath an adequate amount of time. In some embodiments, the advancement members 325 can include a plurality of fingers 330 that extend into the agent and move along a chain drive extending from the first end portion 315 to the second end portion 320. The plurality of fingers 330 are preferably oriented on an elongate arm 335 that is positioned transversely to a bathing path direction that extends from the first end portion 315 toward the second end portion 320. The plurality of fingers 330 are preferably spaced along the elongate arm 335 such that adjacent fingers are spaced from each other less than a cross-sectional dimension of the payload.

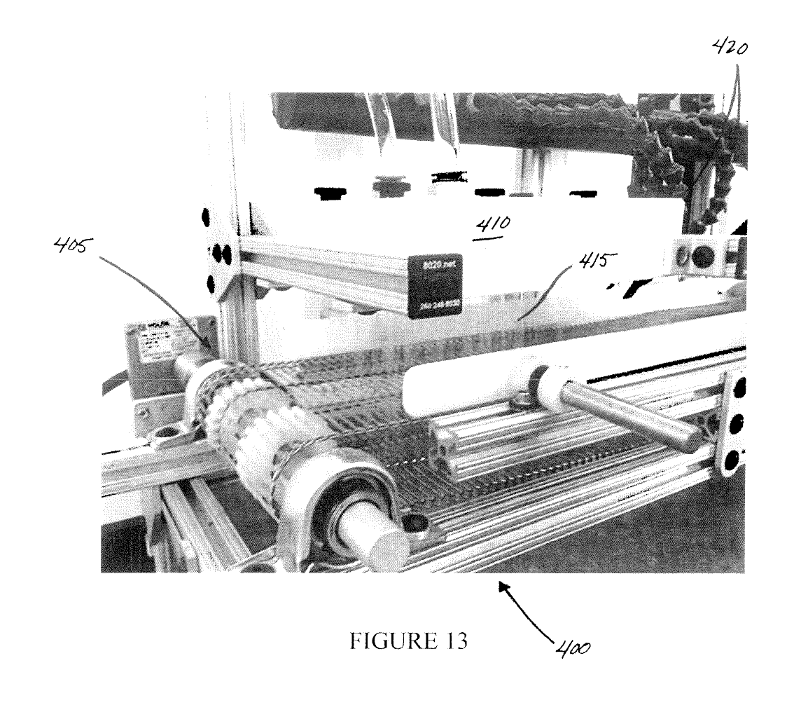

As can be seen from FIG. 12, the plurality of fingers 330 dip into the bath 300 and the polymerizing agent at the first end portion 315 and are advanced toward the second end portion 320 while remaining within the bath 300 and the polymerizing agent. As the plurality of fingers 330 approach the second end portion 320, the elongate arm 335 is rotated to raise the plurality of fingers 330 outside the bath 300 and the polymerizing agent. As the elongate arm 335 is rotated, the plurality of fingers 330 draw the payload with the polymeric coating out of the bath 300. The payload and polymer coating may then be deposited at a cleaning subsystem 400 (FIG. 13).

In some embodiments, the plurality of fingers 330 are provided on stationary rotating drums (not shown) that each conduct the payload through a portion of the pathway between the first end portion 315 and the second end portion 320. The plurality of fingers 330 are preferably positioned in rows along the drum that are separated by about a 90° angle. The plurality of fingers 330 of adjacent drums can be interlaced to capture payloads being released by the previous drum and plurality of fingers 330.

The speed at which the plurality of fingers 330 passes the payload through the bath 300 is preferably configured to provide adequate time for the polymerizing agent to interact with the fluid to create a polymer coating around the payload. In some embodiments, the agent includes a calcium liquid that interacts with an alginate fluid to form a polymeric membrane around the payload. In some embodiments, the speed at which the plurality of fingers 330 passes the payload through the bath 300 is about 2 minutes. In some embodiments, the time for the payload to traverse the bath 300 is between about 1 minute and 3 minutes, and in some embodiments, the time for the payload to traverse the bath 300 is greater than about 3 minutes.

FIG. 13 illustrates a cleaning subsystem 400 that removes unwanted byproducts from the prior processes. For example, in some instances, the polymer coating formed by interacting alginate and calcium (or any unpolymerized component) can create a byproduct that taints the flavor of the payload. The cleaning subsystem 400 gently removes unwanted byproducts of the polymerization process without jeopardizing the structural integrity of the polymer coating.

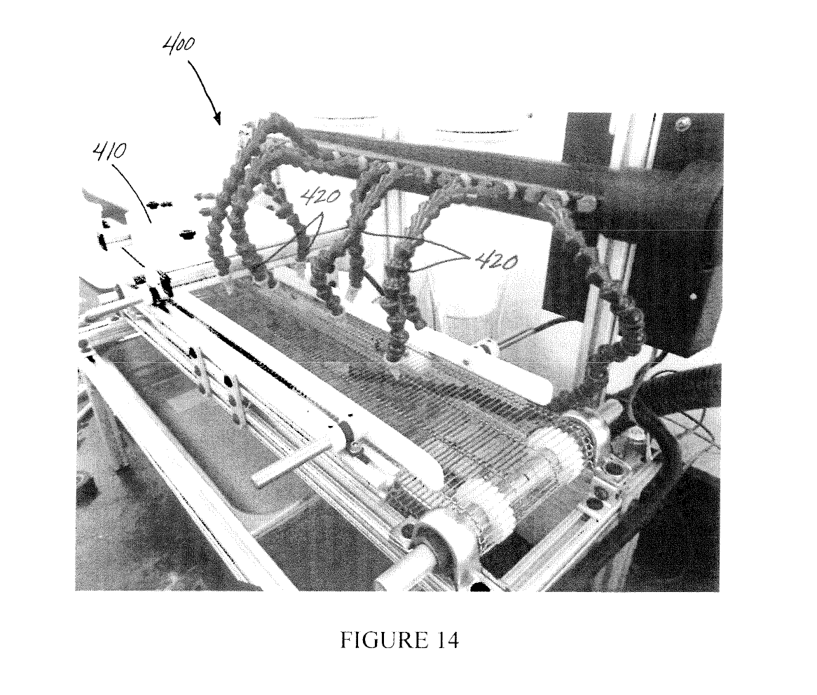

The plurality of fingers 330 of the bath 300 deposits the polymer-coated payload at a receiving end 405. Other methods and structures for transferring the payload with polymer coating to the cleaning subsystem 400 are contemplated. The payload is conducted by a conveyor from the receiving end 405 to a washing portion 410, where a shower of water 415 rinses the polymer coating of the payload. After the shower of water 415, the payload continues on the conveyor and is transported under a plurality of air jets 420 that help dry the payload, as shown in FIG. 14. The air jets 420 preferably blow air onto the rinsed payloads at a pressure of less than about 60 psi. In some embodiments, the payload may be passed through a bath of water prior to having the air jets 420 blow on the payload. Depending on the strength of the polymer coating, the air jets 420 can have a pressure at or greater than 60 psi, but if the pressure of the air jets 420 is too great, the air can sever or otherwise jeopardize the integrity of the polymer coating.

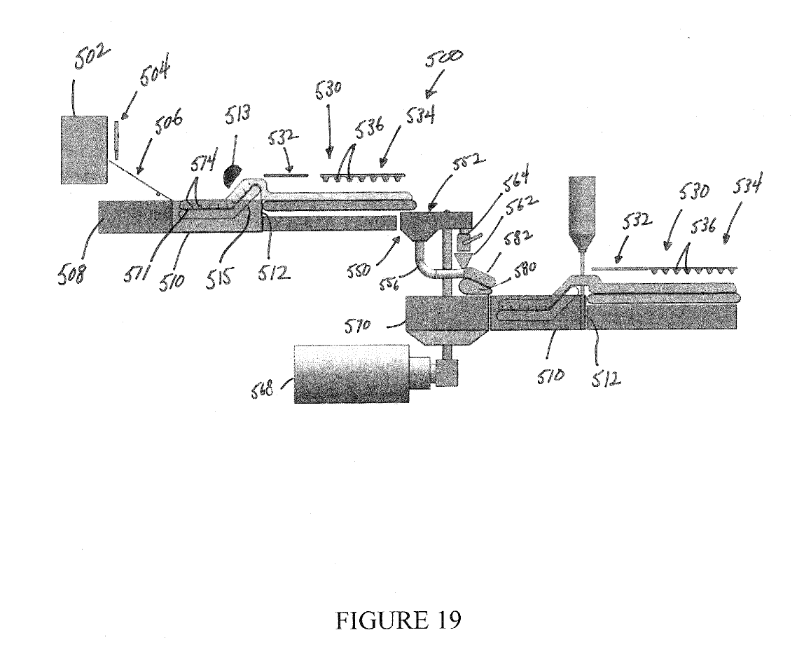

FIG. 19 illustrates a schematic side view of a coating system 500 that incorporates many of the embodiments described herein. The system 500 includes a payload reservoir 502 that can include a liquid or solid payload to be coated with a membrane by the coating system 500. The payload reservoir 502 is connected to a delivery system 504 which can be an extrusion system for liquid payload delivery. A payload is received from the payload reservoir 502 and delivered by the delivery system 504 to a transfer mechanism 506, which operates to coat the payload with a first fluid in a first fluid source, or a coating reservoir 508.

As discussed with other embodiments described herein, the first fluid is preferably a fluid that can be polymerized by reacting with a second fluid at a second fluid source, or polymerizing bath 510. The second fluid in the polymerizing bath 510 can include a polymerizing agent. For example, in some embodiments, the first fluid in the coating reservoir 508 includes alginate, and the polymerizing agent in the polymerizing bath 510 includes calcium. Accordingly, after the payload is coated with alginate at the coating reservoir 508, a polymer coating around the payload can be formed by treating the alginate-coated payload with a calcium polymerizing agent in the polymerizing bath 510. The polymerizing bath 510 can operate in a manner similar to the polymerizing bath 300 described herein.

The transfer mechanism 506 conducts the payload from the coating reservoir 508 to the polymerizing bath 510. The polymerizing bath 510 can include a translating platform 511 that carries the payload through the second fluid to an end portion 512 of the polymerizing bath 510. In some embodiments, the translating platform 511 can include a plurality of transverse dividers 514 that extend across the translating platform 511 along a direction transverse to a direction of travel of the translating platform 511. The transverse dividers 514 are designed to partition sections of the translating platform 511 that receive a coated payload from the transfer mechanism 506 and to convey the coated payload through and beneath a top surface of the second fluid.

As illustrated, the translating platform 511, as it approaches the end portion 512 of the polymerizing bath 510, can be oriented in an upward tilted direction, raising the translating platform 511, the transverse dividers 514, and the payload out of the second fluid. The polymerizing bath 510 can include a series of air knives 513 that are directed at the translating platform 511 and the payload at the upward tilted portion 515 to assist in removal of excess fluid on the payload.

One notable difference between polymerizing bath 510 and polymerizing bath 300 described herein is that polymerizing bath 510 is configured to convey payloads through the polymerizing agent when the payload sinks in the polymerizing agent. Polymerizing bath 300 conveys payloads through the polymerizing agent when the payload floats. It is to be understood that modifications relating to specific geometries of the baths 300, 510 and the mechanisms used to convey payload through the polymerizing agent can be made such that polymerizing bath 510 conveys payloads that float in the polymerizing agent, and such that polymerizing bath 300 conveys payloads that sink in the polymerizing agent. For example, polymerizing bath 510 can include the fingers of polymerizing bath 300 in place of the transverse dividers 514. Additionally, polymerizing bath 300 can include solid dividers in place of the fingers.

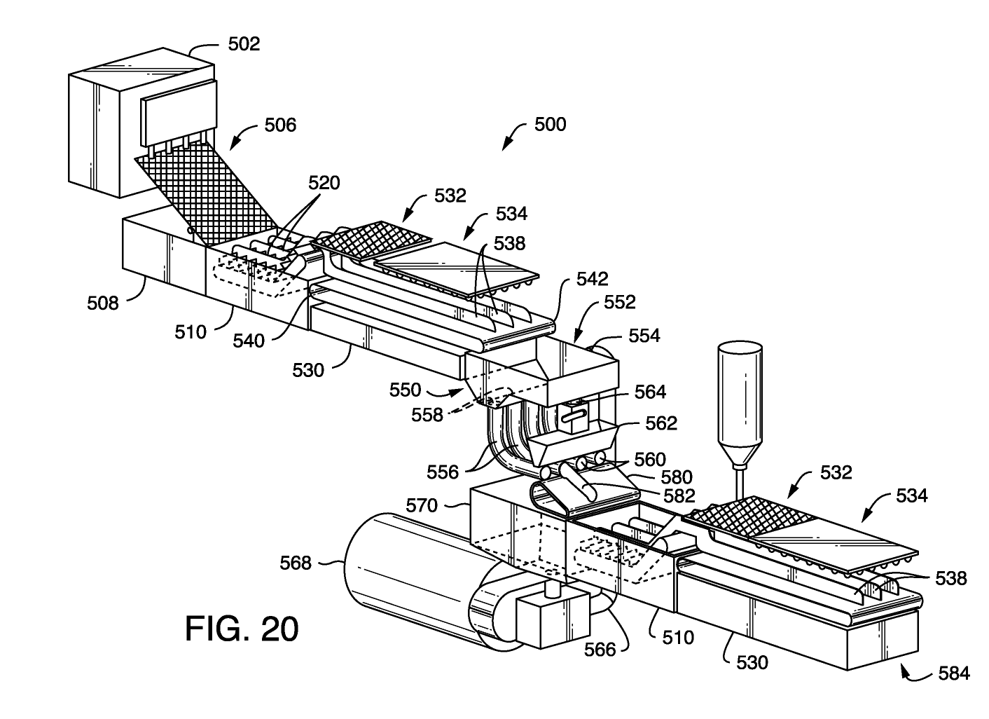

Translating platform 511 can include a plurality of longitudinal dividers 520 that extend longitudinally along the direction of travel of the translating platform 511, as illustrated in FIG. 20. The longitudinal dividers 520 allow for a plurality of payloads to be conveyed through the polymerizing bath 510 at the same time while keeping the payloads separate from other payloads. One reason for maintaining separation between payloads is to ensure that the coating material on each payload is exposed as much as possible to the polymerizing agent. If too many payloads are conveyed through a bath together, there is an increased risk that adjacent payloads may contact one another and limit exposure of the respective coating materials to the polymerizing agent in the bath.

The payload is delivered from the end portion of the polymerizing bath 510 to a conveyer 530 that conducts the payload beneath four through a washing area 532 and a drying area 534. As described herein in other embodiments, the washing area 532 can include a plurality of sprays that shower water or another cleansing agent over the payloads to remove excess polymerizing agent from the payload. Also as described herein, the drying area 534 can include a plurality of air jets 536 that dries the water or other cleansing agent on the payload. The conveyer 530, as illustrated in FIG. 20, can include a plurality of longitudinal dividers 538 similar to those described herein with respect to the polymerizing bath 510. The payload is conveyed on the conveyer 530 from a first end 540 of the conveyer 530 toward a second end 542 of the conveyer 530.

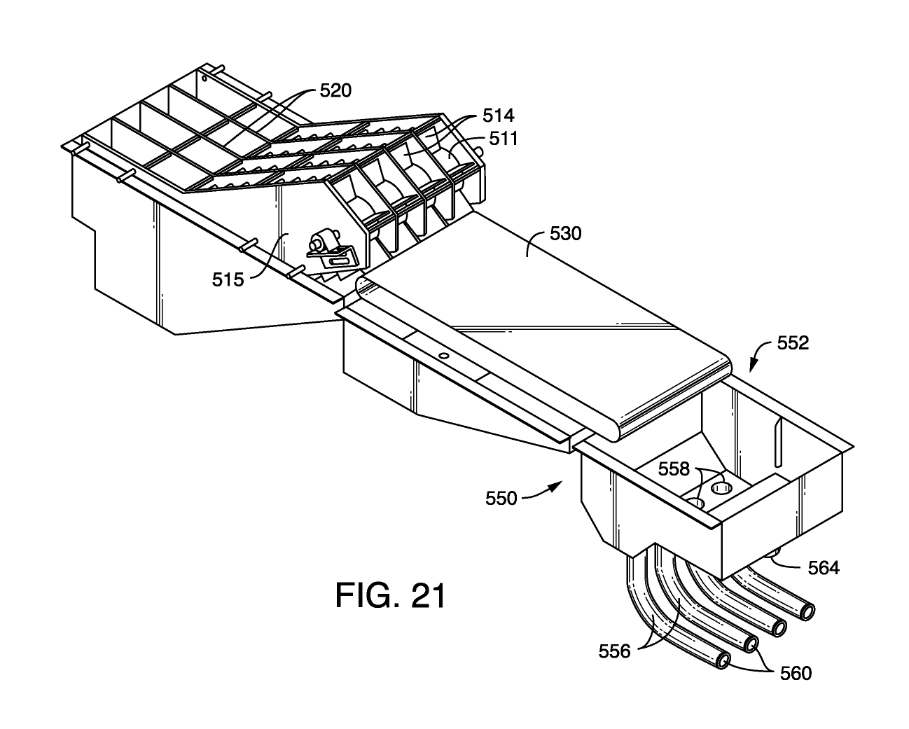

At this point, the payload is coated with a membrane that has been washed and dried. In some embodiments, this coating is all that is desired for the payload. In other embodiments, it may be desirable to provide a second membrane over the first membrane. For example, in some instances when the payload is a liquid, it may be desirable to provide a first membrane around the liquid prior to applying a second membrane over the first membrane. Accordingly, the coating system 500 can be divided into multiple modular components that can be removed, inserted, and/or replaced, as illustrated in FIG. 21. These modular components permit flexibility with respect to different payload types and objectives.

The coating system 500 can include a system for conducting quality control along the conveyer 530. For example, as the payload is conducted toward the second end 542 of the conveyer 530, the payload may be inspected to determine if there is a reason to reject the coated payload. The inspection may be conducted in one or more of many ways. In some embodiments, a camera may capture an image of the payload as it is conducted, and the image may be compared with a database of acceptable geometries, colors, shapes, and sizes. If the conducted payload has features that exceed a tolerable threshold designated in the inspection process, the payload may be rejected. In some embodiments, the payload can be weighed as it is conducted toward the second end 542. The weight of the payload can be compared to an acceptable threshold of weights, and if the weight of the payload is outside of the threshold of weights, the payload may be rejected.

In the embodiments depicted in FIGS. 19 and 20, at the second end of the conveyer 542, the payload is delivered to an enrober 550. In some embodiments, enrobers described herein may be used. In some embodiments, enrober 550 may be used to apply a second layer over the coated payload. Enrober 550 may operate in a similar manner as enrober 260, described herein in connection with FIGS. 15-18. For example, enrober 550 includes a reservoir 552 that receives coating fluid at an inlet portion 554 of the reservoir. The fluid is conducted by a plurality of enclosed enrobing channels 556 that receive the fluid at a respective inlet 558 of the enclosed enrobing channels 556. The enclosed enrobing channels 556 are fluidly coupled to the reservoir 552 and are configured to conduct fluid from the inlet 558 toward respective enclosed enrobing channel outlets 560.

A coating fluid curtain can be formed at the outlets 560, as described herein, by a fluid dispenser 562. In some embodiments, as illustrated, the fluid dispenser 562 can include a trough with an opening at the bottom to permit coating fluid to be poured over the outlets 560 of the enclosed enrobing channels 556. Coating fluid is conveyed to the fluid dispenser 562 by a curtain channel 564 that receives fluid from the reservoir 552 and conducts the fluid to the fluid dispenser 562.

Coating fluid is conducted to the reservoir 552 by a supply line 566. Fluid is driven through the supply line 566 by a pump 568, which can be a rotary pump. The supply line 566 receives the fluid from a reservoir 570 that contains the coating fluid and is configured to capture excess fluid during the enrobing process.

Although not illustrated in FIG. 20, the enrober 550 can include one or more dividers in the reservoir 552 to keep separate the payloads as they are received within the enrober 550. The dividers can be similar in structure to the longitudinal divider 520 of the polymerizing bath 510 or the longitudinal dividers 538 of conveyer 530. The enrober 550 dividers can also help control the fluid dynamics of the fluid within the enrober 550. For example, the dividers can extend to a base the enrober 550 between each of the inlet 558, thereby limiting interaction between adjacent vortices formed as the fluid flows into the enclosed enrobing channels 556.

Enrober 550 can also include a bi-level base, as illustrated in FIG. 20. In some embodiments, a base of the enrober 550 at the inlets 558 can be lower than a base of the enrober 550 that feeds fluid into the curtain channel 564. In some embodiments, the transition from the higher base to the lower base can include an angled wall that directs fluid to flow from the higher base toward the lower base. In some embodiments, the bi-level base can provide a greater pressure of fluid at the lower base for purposes that may operate more effectively with a higher fluid pressure. For example, it may be advantageous in some instances to have a higher fluid pressure at the inlet 558 of the enclosed enrobing channels 556, to conduct the payloads through the enclosed enrobing channels 556, than a fluid pressure leading to the curtain channel 564, which does not conduct a payload therethrough.

At the outlets 560 of the enclosed enrobing channels 556, an adjustable ramp 580 can be provided to receive payloads emerging from the outlets 560. The ramp 580 is preferable a chain conveyor belt that receives payloads at a first location and conducts them to a second location. As the ramp 580 is the transition mechanism between the enclosed enrobing channels 556 and, for example, a polymerizing bath 510, a length of the ramp is preferably configured to allow excess fluid from the enrober 550 to fall off the payload and fall to the reservoir 570. A further factor that can affect the amount of excess fluid permitted to be removed from the payload along the ramp 580 is the angle of the ramp. In some embodiments, the ramp 580 is angled downward between about 10 degrees and about 45 degrees from a horizontal level. The ramp 580 can be adjusted in height or angle to accommodate payloads with varying shapes, sizes, weights, and treatment. In some embodiments, the length of the ramp and angle is optimized for draining excess fluid from the payload and ramp 580 to the reservoir 570. The ramp 580 can include one or more dividers 582 to keep payloads separate from adjacent payloads being conducted on the ramp 580. In some embodiments, the dividers 582 may be spaced from adjacent dividers 582 by about 4 inches to about 10 inches, depending on the desired width of the respective payload. In some embodiments, the spacing of the dividers 582 can be adjusted to accommodate payloads of varying size. In some embodiments, a total width of the belt, or the ramp 580, is between about 12 inches and about 48 inches, depending on the desired payload size that is being processed and the volume of payloads being simultaneously processed. In some embodiments, the total width of the ramp 580 can be greater than about 48 inches.

The adjustable ramp 580 operates to conduct the payload from the outlets 560 of the enclosed enrobing channels 556 to the next stage in the process, which can include a modular polymerizing bath 510 and conveyer 530 as described herein. After the payload passes through the polymerizing bath 510 and is washed and dried along the conveyer 530, the payload emerges at an end portion 584 of the coating system 500 with a coating of two membranes.

The modularity of the various components of the coating system 500 permits a variety of coating processes that can be tailored to the needs or desires of different payloads. For example, if additional layers were desirable, an additional enrober and polymerizing bath could be added to the one depicted in FIGS. 19 and 20. FIG. 21 depicts three of the described modular complements, including a polymerizing bath 510, a conveyer 530, and an enrober 550. Although the coating system 500 is depicted in FIGS. 19 through 21 as including an enrober 550 following the conveyer 530, in some embodiments, a coating system such as that described herein in connection with coating reservoir 508 and transfer mechanism 506 can be provided following the conveyer 530. Additionally, in some embodiments, enrober 550 may be used in one or more positions of the coating system 500 to apply a layer of the first fluid on the payload. In some embodiments, multiple polymerizing baths 510 of the coating system 500 can include different polymerizing agents depending upon the coating fluid that is applied to the payload. For example, in some embodiments, the polymerizing agent of the first polymerizing bath 510 can include calcium, and the polymerizing agent of the second polymerizing bath can include a polymerizing agent that does not include calcium. In some embodiments, the same coating fluid may be used in multiple instances, thereby obviating the need of separate baths.

Adjustable ramp 580 is described herein as providing a transfer mechanism from the enrober 550 to polymerizing bath 510. Other transfer mechanisms 506 can be used in the coating system 500, particularly in connection with a payload reservoir 502, delivery system 504, coating reservoir 508, and polymerizing bath 510, as illustrated in FIGS. 19 and 20. Some embodiments of a transfer mechanism 506 are described in co-owned U.S. Application No. 61/885,435, entitled, “Pneumatic Transfer Device,” the entirety of which is incorporated herein by reference.

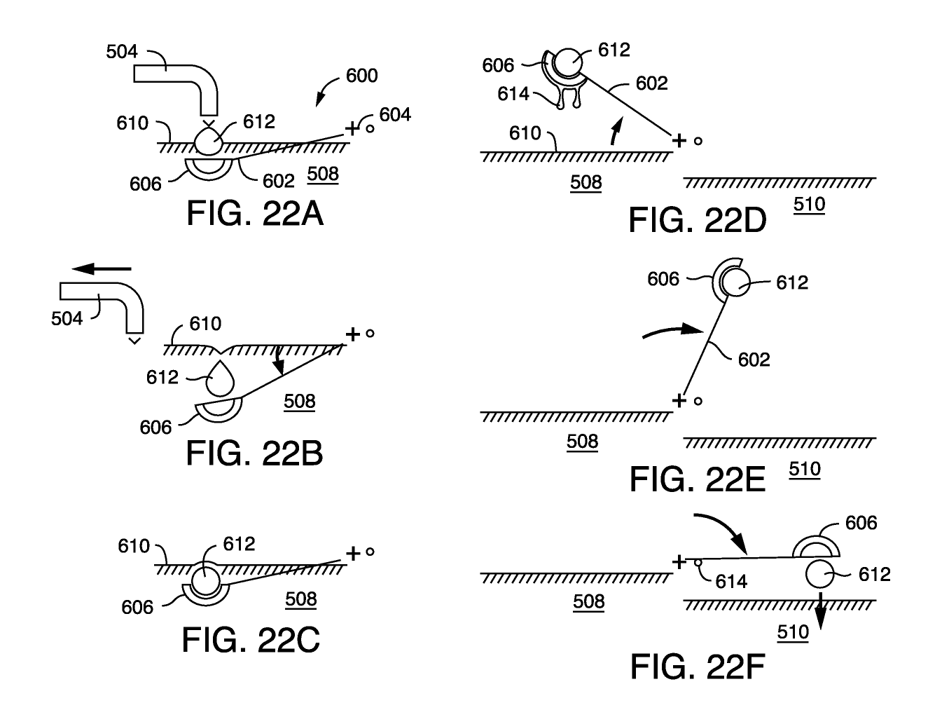

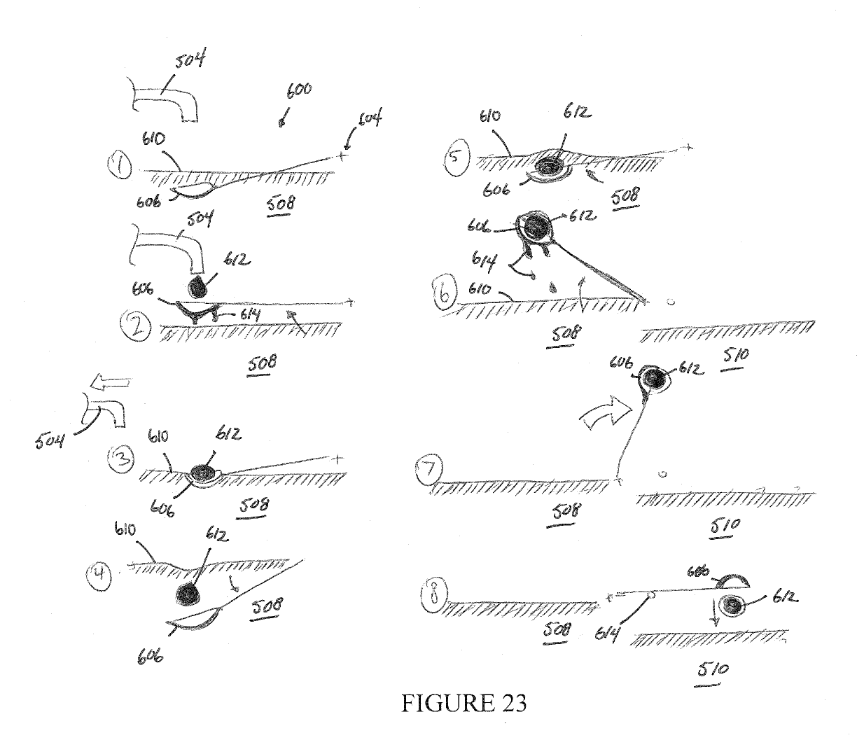

FIGS. 22A-22F and 23 depict schematic images reflecting a transfer mechanism 506 for transferring the payload from a coating reservoir 508 to a polymerizing bath 510. FIGS. 22A-22F depict a six-step process, during which a payload is delivered to a transfer device 600 that includes an elongate member 602 that moves about, or pivots about, an axis of rotation 604 from a first position, in which the first end 606 of the transfer device 600 receives the payload at the coating reservoir 508, to a second position, in which the first end 606 delivers the payload to a polymerizing bath 510.

In Step 1 depicted in FIG. 22A, the first end 606 of the transfer device 600 is positioned beneath a top surface 610 of the fluid contained in the coating reservoir 508. Delivery system 504 delivers a payload 612 toward the first end 606 of the transfer device 600. The transfer device 600 is moved deeper into the fluid, as illustrated in Step 2 depicted in FIG. 22B, and movement of the first end 606 through the fluid creates a low-pressure zone that draws the payload 612 to follow the movement of the first end 606 through the fluid. The viscosity of the fluid, the speed of movement of the first end 606 through the fluid, and the buoyancy of the payload 612 within the fluid, is configured such that the first end 606 is separated from the payload 612 as the transfer device 600 is moved deeper into the fluid. Separation between the first end 606 and the payload 612 allows the payload 612 to be fully covered by the fluid of the coating reservoir 508. The delivery system 504 can be moved as indicated in Step 2 in order to avoid interference of subsequent movement by the transfer device 600.

In Step 3 depicted in FIG. 22C, the transfer device 600 has stopped moving deeper into the fluid, and has moved back toward the top surface 610 of the fluid. The first end 606 has also pressed the payload 612 toward the top surface 610. Step 4, depicted in FIG. 22D, depicts further movement of the transfer device 600 beyond the top surface 610 of the fluid, and the first end 606 is shown as lifting the payload 612 above the fluid. Excess fluid 614 is permitted to drain off the payload 612 and the first end 606 back into the coating reservoir 508. In some embodiments, additional measures may be taken to facilitate removal of excess fluid from the payload 612. For example, in some embodiments, an air jet or squee-gee may be used to blow off wipe off excess fluid from the payload 612.

Step 5, depicted in FIG. 22E, illustrates further movement of the coated payload 612 carried by the first end 606 from the coating reservoir 508 toward the polymerizing bath 510. Step 6, depicted in FIG. 22F, illustrates that the transfer device 600 has engaged a stop 614, which prevents further movement of the transfer device 600. The coated payload 612, in this step, is delivered from the first end 606 into the polymerizing bath 510.

FIG. 23 illustrates another process for coating a payload 612 with fluid at the coating reservoir 508 and transferring the coated payload 612 to a polymerizing bath 510. In Step 1, the first end 606 is shown as being submerged beneath the top surface 610 of the fluid. In Step 2, the transfer device 600 is moved such that the first end 606 is elevated above the top surface 610, and excess fluid 614 is permitted to drain from the first end 606 into the coating reservoir 508. At this point, payload 612 is delivered from the delivery system 504 to the first end 606 of the transfer device 600. Step 3 illustrates possible movement of the delivery system 504 to avoid subsequent interference with movement of the transfer device 600, and the first end 606 is moved into the fluid of the coating reservoir 508.

In Step 4, the transfer device 600 is moved deeper into the fluid, and movement of the first end 606 through the fluid creates a low-pressure zone that draws the payload 612 to follow the movement of the first end 606 through the fluid. Similar to the process described in connection with FIGS. 22A-22F, the viscosity of the fluid, the speed of movement of the first end 606 through the fluid, and the buoyancy of the payload 612 within the fluid, is configured such that the first end 606 may be separated from the payload 612 as the transfer device 600 is moved deeper into the fluid.

In Step 5, the transfer device 600 has stopped moving deeper into the fluid, and has moved back toward the top surface 610 of the fluid. The first end 606 has also pressed the payload 612 toward the top surface 610. Step 6 depicts further movement of the transfer device 600 beyond the top surface 610 of the fluid, and the first end 606 is shown as lifting the payload 612 above the fluid. Excess fluid 614 is permitted to drain off the payload 612 and the first end 606 back into the coating reservoir 508.

Step 7 illustrates further movement of the coated payload 612 carried by the first end 606 from the coating reservoir 508 toward the polymerizing bath 510. Step 8 illustrates that the transfer device 600 has engaged stop 614, which prevents further movement of the transfer device 600. The coated payload 612, in this step, is delivered from the first end 606 into the polymerizing bath 510.

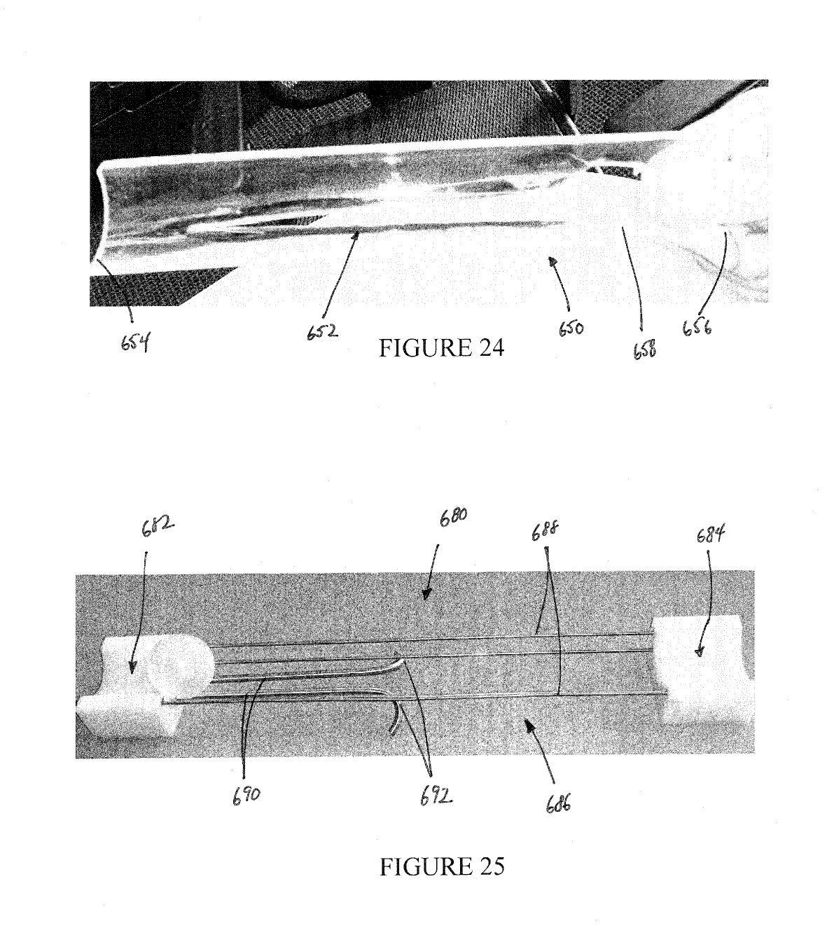

FIGS. 24-26 illustrates different embodiments of the transfer device 600. FIG. 24 illustrates a transfer device 650 that is an elongate member having a semi-cylindrical shape. The transfer device 650 includes a channel 652 that begins near a first end 654 and extends towards a second end 656. The channel 652 has an increasing maximum cross-sectional dimension as the channel extends in a direction from the first end 654 toward the second end 656. At the end of the channel 652 near the second end 656, the channel opens to define an enlarged opening 658 that is sized to permit a payload to pass through the enlarged opening 658.

In operation, the transfer device 650 is dipped into the fluid at the coating reservoir 508 prior to receiving a payload near the first end 654. As described with reference to FIGS. 22A-22F and 23, the transfer device 650 can receive the payload above or below the top surface of the fluid within the coating reservoir 508. After the payload is submerged within the fluid of the coating reservoir 508 and afterward raised above the fluid, the transfer device 650 can be tilted to encourage sliding or rotational movement of the payload along the transfer device 650 from the first end 654 toward the second end 656. As the payload moves over the channel 652, excess fluid is permitted to be drained from the payload and the transfer device 650 to the coating reservoir 508. When the payload reaches the enlarged opening 658, the payload is permitted to pass through the enlarged opening 658 and to be deposited into the next stage, which can be, for example, the polymerizing bath 510.

FIG. 25 illustrates a transfer device 680 that is an elongate member having a first end portion 682, a second end portion 684, and an intermediate portion 686 between the first end portion 682 and the second end portion 684. The intermediate portion 686 may include a plurality of guide rods 688 that extend from the first end portion 682 to the second end portion 684. The intermediate portion 686 may also include a plurality of support rods 690 that extend from the first end portion 682 in a direction substantially parallel to a direction from the first end portion 682 toward the second end portion 684. The support rods 690 preferably extend only partially between the first end portion 682 and the second end portion 684. At an end 692 of the support rods 690 spaced from the first end portion 682, the support rods 690 extend in a direction transverse to the direction from the first end portion 682 toward the second end portion 684. Accordingly, in some embodiments, there are no support rods 690 between the support rod ends 692 and the second end portion 684. The guide rods 688 are preferably spaced to permit a payload to be received between the guide rods 688, and the support rods 690 are preferably spaced not to permit a payload to pass between the support rods 690.

In operation, the transfer device 680 may be dipped into the fluid at the coating reservoir 508 prior to receiving a payload near the first end portion 682. As described with reference to FIGS. 22A-22F and 23, the transfer device 680 can receive the payload above or below the top surface of the fluid within the coating reservoir 508. After the payload is submerged within the fluid of the coating reservoir 508 and afterward raised above the fluid, the transfer device 680 can be tilted to encourage sliding or rotational movement of the payload along the transfer device 680 from the first end portion 682 toward the second end portion 684. As the payload moves, the payload is supported underneath by support rods 690 and is guided on its sides by guide rods 688. Excess fluid is permitted to be drained from the payload and the transfer device 680 to the coating reservoir 508 by dripping between the support rod 690 and the guide rods 688. When the payload reaches the end 692 of the support rods 690, the payload is permitted to pass between the guide rods 688 and to be deposited into the next stage, which can be, for example, the polymerizing bath 510.

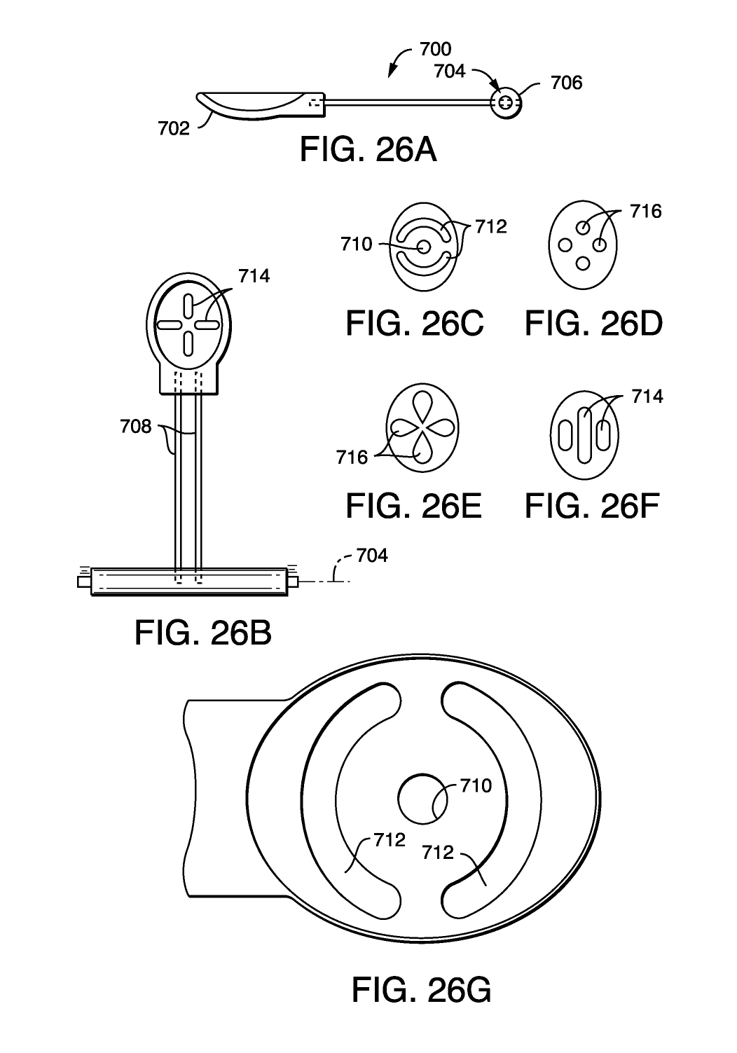

FIGS. 26A-26G illustrate embodiments of a transfer device 700 that is configured to carry a payload at a first end 702 and to be rotated about an axis of rotation 704 at a second end 706 of the transfer device 700. Although the transfer device 700 is illustrated as including a plurality of rods 708 extending between the first end 702 and the second end 706, the rods 708 may be replaced with one or more solid elongate members. Transfer device 700 is configured to operate similar to the processes depicted in FIGS. 22A-22F and 23, rotating about the axis of rotation 704 to conduct a payload from the coating reservoir 508 to a polymerizing bath 510.

The first end 702 can include one or more apertures and/or channels extending therethrough to facilitate drainage of excess fluid from the payload and the transfer device 700 while the payload is being transferred. As depicted in FIGS. 26C and 26G, in one embodiment, the first end 702 can have a central aperture 710 and a plurality of arcuate channels 712 extending around the central aperture 710. In some embodiments, the first end 702 can include four substantially straight channels 714 that are oriented transverse to others of the straight channels. For example, as illustrated, the four straight channels 714 can be oriented at 90° relative to adjacent channels 714. In some embodiments, the first end 702 can include more than one aperture 716, and in some embodiments, the more than one aperture 716 can be substantially cylindrical, while in other embodiments, the more than one aperture 716 can have a different shape, for example, a teardrop shape. In some embodiments, the first end 702 can include a plurality of straight channels 714 that are all oriented in the same direction, and that vary in length. As mentioned herein, additional measures may be taken to facilitate removal of excess fluid from a bottom surface of the transfer device 700. For example, in some embodiments, an air jet can be projected toward the bottom surface of the transfer device 700 and/or the payload as the payload is lifted out of the coating reservoir 508 toward the polymerizing bath 510. In some embodiments, a squee-gee may be passed underneath the transfer device 700 to actively scrape excess fluid from the bottom surface of the transfer device 700 and to deposit the excess fluid into the coating reservoir 508.

In some embodiments of the coating system 500, the transfer mechanism 506 can be a rotating platform as illustrated in FIGS. 19 and 20. In some embodiments, the rotating platform can be a plurality of rods that are rotated to conduct the payload from the fluid reservoir 508 toward the polymerizing bath 510. The plurality of rods can be similar to those rods described herein in connection with the embodiments depicted in FIG. 25.

The previous description is provided to enable any person skilled in the art to practice the various aspects described herein. While the foregoing has described what are considered to be the best mode and/or other examples, it is understood that various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the terms “a set” and “some” refer to one or more. Pronouns in the masculine (e.g., his) include the feminine and neuter gender (e.g., her and its) and vice versa. Headings and subheadings, if any, are used for convenience only and do not limit the invention.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. A phrase such an embodiment may refer to one or more embodiments and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed:

1. An enrober for coating a payload with a fluid, comprising: a reservoir configured to receive coating material and the payload; and an enclosed enrobing channel, fluidly coupled to the reservoir at an enclosed enrobing channel inlet, configured (i) to receive the coating material and the payload from the reservoir, and (ii) to conduct the coating material and the payload to an enclosed enrobing channel outlet; wherein when the payload is introduced into the reservoir, flow of the coating material conducts the payload from the reservoir into and through the enclosed enrobing channel prior to discharge of the payload from the enclosed enrobing channel outlet.

2. The enrober of claim 1, wherein the reservoir is configured for vortex formation in the flow of the coating material at the inlet of the enclosed enrobing channel.

3. The enrober of claim 2, wherein the reservoir is configured to receive the payload adjacent to the vortex of the enclosed enrobing channel.

4. The enrober of claim 1, wherein the reservoir comprises a bypass flow channel that limits a depth of the coating material in the reservoir by discharging excess coating material through the bypass flow channel when the coating material exceeds a pre-determined depth.

5. The enrober of claim 1, wherein the enclosed enrobing channel comprises a maximum internal cross-sectional dimension that is between about 4 and 1.1 times a payload maximum outer cross-sectional dimension.

6. The enrober of claim 1, further comprising a curtain channel that is configured to conduct the coating material proximal to the enclosed enrobing channel outlet.

7. The enrober of claim 6, wherein the curtain channel outlet is configured to form a curtain of coating material proximal to the outlet of the enclosed enrobing channel, the curtain having a diameter about the same as an enclosed enrobing channel diameter.

8. The enrober of claim 6, wherein the curtain channel outlet is configured to conduct coating material across the outlet of the enclosed enrobing channel.

9. The enrober of claim 6, wherein the curtain channel is located such that the coating material discharged from the curtain channel outlet is configured to fall on the enclosed enrobing channel near the enclosed enrobing channel outlet to form a curtain of coating material across the enclosed enrobing channel outlet.

10. The enrober of claim 9, wherein the curtain comprises a cross-sectional thickness less than a cross-sectional thickness of the coating material when it is discharged from the curtain channel outlet.

11. The enrober of claim 1, comprising a plurality of enrobing channels.

12. The enrober of claim 1, further comprising one or more payload sources positioned above the reservoir that are configured to deliver the payload to the reservoir.

13. A method for coating a payload, comprising:
providing an enrobing reservoir having a an enclosed enrobing channel connected to the enrobing reservoir at an inlet of the enclosed enrobing channel;
directing a coating material into the enrobing reservoir such that the fluid flows within the enrobing reservoir toward the inlet of the enclosed enrobing channel;
directing the payload to the enrobing reservoir and depositing the payload in the enrobing reservoir adjacent to the inlet of the enclosed enrobing channel; and
conducting the payload through the enrobing reservoir inlet and into the enclosed enrobing channel to be discharged at an enclosed enrobing channel outlet.

14. The method of claim 13, further comprising forming a vortex flow within the coating material in the reservoir at the reservoir outlet.

15. The method of claim 14, wherein the payload is delivered into the vortex flow within the coating material.

16. The method of claim 13, wherein the coating material is deposited into the reservoir at a portion distal to the reservoir outlet.

17. The method of claim 13, wherein a depth of the coating material within the reservoir is limited by discharging excess coating material through a bypass flow channel when the coating material exceeds a pre-determined depth.

18. The method of claim 18, wherein the curtain is formed by discharging coating material from a curtain channel onto the enclosed enrobing channel proximal to the enclosed enrobing channel outlet.

19. The method of claim 13, comprising a plurality of enrobing channels.

20. An enrober for coating a payload with a fluid, comprising: a reservoir configured to receive coating material and the payload; an enclosed enrobing channel, fluidly coupled to the reservoir at an enclosed enrobing channel inlet, configured (i) to receive the coating material and the payload from the reservoir, and (ii) to conduct the coating material and the payload to an enclosed enrobing channel outlet; and an extension coupled to the enclosed enrobing channel outlet and configured to modulate a fluid back-pressure in and/or volumetric fill of the enclosed enrobing channel; wherein when the payload is introduced into the reservoir, and flow of the coating material conducts the payload from the reservoir into and through the enclosed enrobing channel and the extension prior to discharge of the payload from the extension.
